(19) United States
(12) Patent Application Publication
(10) Pub. No.: US 2017/0145316 A1
(43) Pub. Date: May 25, 2017

(54) DISPERSING AND FLATTENING APPARATUS FOR UNIFORM DRYING OF TRANSPORTATION COALS IN COAL DRYER USING REHEAT STEAM

(71) Applicant: HANKOOK TECHNOLOGY INC., Seoul (KR)

(72) Inventor: Sung Kon KIM, Anyang-si, Gyeonggi-do (KR)

(73) Assignee: HANKOOK TECHNOLOGY INC., Seoul (KR)

(21) Appl. No.: 15/320,287

(22) PCT Filed: Jun. 17, 2015
(86) PCT No.: PCT/KR2015/006139

§ 371 Date: Dec. 19, 2016

(30) Foreign Application Priority Data
Jun. 17, 2014 (KR) 10-2014-0073203
Jun. 17, 2014 (KR) 10-2014-0073207
Nov. 28, 2014 (KR) 10-2014-0168687
Nov. 28, 2014 (KR) 10-2014-0168731
Nov. 28, 2014 (KR) 10-2014-0168757
Nov. 28, 2014 (KR) 10-2014-0168785
Jan. 2, 2015 (KR) 10-2015-0000085
Jan. 2, 2015 (KR) 10-2015-0000087
Jan. 2, 2015 (KR) 10-2015-0000092
Jan. 2, 2015 (KR) 10-2015-0000098
Jan. 2, 2015 (KR) 10-2015-0000099

(51) Int. Cl. C10B 57/10; F26B 3/06; F26B 17/02; C10L 5/04

(52) U.S. Cl. CPC C10B 57/10; C10L 5/04; F26B 3/06; F26B 17/026; C10L 2290/08; C10L 2290/06

(57) ABSTRACT

The present invention relates to an apparatus that reduces loads of piles of coals that are input from a fixed quantity coal supplier via a pulverizer to a multi-stage dryer and are transferred, and uniformly disperses and flattens the piles of the coals, thereby improving drying efficiency, in the multi-stage dryer that dries coals using reheat steam, wherein coals that are primarily dried by the first coal dryer are input into the second coal dryer to be secondarily dried, the apparatus including: a column-shaped body that is installed on surfaces of the plurality of first transfer plates and second transfer plates, which faces an upper side, at a specific interval; a division boss that protrudes from a central portion of a front surface of the body to divide and disperse a central portion of piles of coals input from a fixed quantity coal supplier onto the surfaces of the first transfer plates and the second transfer plates, which face an upper side, into left and right parts; and a pair of fixing members that are fixed at upper ends of the first guide rails and the second guide rails that horizontally support the first transfer plates and at upper ends of the third guide rails and the fourth guide rails that horizontally support the second transfer plates to fixedly support opposite ends of the body, wherein the piles of the coals that are transferred on the surfaces of the first transfer plates and the second transfer plates, which face an upper side, are flattened at a specific height so that reheat steam sprayed while passing through the first transfer plates and the second transfer plates uniformly comes into contact with surfaces of coal particles.

### TECHNICAL FIELD

The present invention relates to an apparatus for dispersing and flattening transportation coals in a coal dryer using reheat steam and, more particularly, to an apparatus that reduces loads of piles of coals that are input from a fixed quantity coal supplier via a pulverizer to a multi-stage dryer and are transferred, and uniformly disperses and flattens the piles of the coals, thereby improving drying efficiency, in the multi-stage dryer that dries coals using reheat steam.

### BACKGROUND ART

In general, in a thermal power plant that generates power by using coal as fuel, coals of approximately 180 ton/hr per 500 MW are combusted, and each pulverizer supplies coals of approximately 37 ton to a boiler. In a thermal power plant of 500 MW which uses coal, approximately six coal storage silos each having a capacity of approximately 500 ton are installed. Five of them are for normally supplying coals and the other one is operated as a coal storage silo that preliminarily stores coal that may be used for a predetermined period of time.

In addition, in the thermal power plant that generates power by using coal as fuel, the standard thermal power design criterion for coal is designed to use a low moisture bituminous coal of 6,080 Kcal/Kg and 10% or less. In some thermal power plants, imported coals are used. Among the imported coal, some sub-bituminous coals has an average moisture water content of 17% or more, so that combustion efficiency of the boiler is reduced. When the standard thermal power combustion limit is 5,400 Kcal/Kg and a caloric value of the coals is low, a reduction in a power generation amount and an increase in a fuel consumption amount are predicted due to a reduction in the combustion efficiency. In addition, when sub-bituminous coals which are high-moisture low caloric coals are used, a moisture content thereof is higher than a design reference, so that a transfer system that carries the coals may not be smoothly operated, efficiency when the coals are pulverized by the pulverizer may be reduced, combustion efficiency may be reduced due to partial incomplete combustion, and windage of distribution of heat generated in the boiler an abnormal operation may occur. However, in the thermal power plant, to reduce fuel costs, a usage ratio of sub-bituminous coals has been gradually increased to approximately 41-60%.

Further, because the global economic recovery is expected and safety issues of a nuclear power plant are faced due to destruction of a nuclear power plant resulting from a Japanese huge earthquake, preference of the thermal power plant becomes high, and thus, it is predicted that demands and prices of the coals are consistently increased. An environment of the world coal market is changed from a customer-centered environment to a supplier-centered environment, and thus, stable supply and demand of coals is different. Further, it is predicted that a production volume of high caloric coals is maintained at a current level, and thus, unbalance of the supply and demand of the coals is predicted.

Although a ratio of low caloric coals among the total deposits of the world's coals is approximately 47%, the low caloric coals have low caloric values and high moisture contents, and thus, the high-moisture low caloric coals have difficulty in complete combustion, for example, a combustion failure during combustion. Accordingly, the low caloric coals are ignored in the market. Globally, until recent years, there has been a high tendency of relying on stable petroleum prices and low production unit prices of the nuclear power plant. However, in recent years, a lot of constructions of the thermal power plants that use coals are planed due to a sharp rise in petroleum prices and a sense of insecurity to the nuclear power generation.

As the conventional technology of drying coals (thermal drying), a rotary drying scheme of drying internal coal particles using high temperature gas while a cylindrical shell into which coals are input is rotated, a flash pneumatic drying scheme of drying coals by raising high-temperature drying gas from below to top while coals are supplied from top to below, and a fluid-bed drying scheme of drying coals by upward raising high-temperature drying gas with fine particles are mainly used.

Moisture of the coals is classified into surface moisture that is attached to pores between coal particles and bound moisture that is coupled to pores inside the coals. Most of the surface moisture is moisture that is sprayed during a washing process in a producing area, transportation and storing, and an amount of the surface moisture is determined based on a surface area and absorptivity. Further, as particles becomes smaller, the surface area becomes larger and capillary tubes between the particles are formed, so that moisture is contained in the coals, and thus, a moisture content is increased. The bound moisture is formed at a creation time of the coals, and bound moistures of brown coal, soft coal (bituminous coal and sub-bituminous coal) and anthracite coal are smaller in the sequence of the brown coal, the soft coal (bituminous coal and sub-bituminous coal) and the anthracite coal. When a large amount of moisture is included in coals, caloric values are reduced and transportation costs are increased, so that it is required to control moisture during processes of mixing, pulverizing and separating coals.

In addition, a problem occurs in that moisture included in coals cannot be effectively dried even by spraying reheat steam in a state in which input coals are not uniformly dispersed, in an apparatus for drying coals by spraying high-temperature reheat steam below a dryer while the pulverized coals are transferred through a multi-stage dryer, that is, a conveyor having a plurality of through-holes formed therein through which reheat steam passes or a plurality of transfer plates that are coupled to each other. Accordingly, problems occur in that stages or lengths of the dryer for drying coals should be enlarged, a supply amount of the reheat steam for drying should be increased, and thus, costs and times according to drying of coals are increased.

Korean Patent No. 10-0960793 as the prior art related to the present invention discloses that a low grade coal stabilizer includes a wave-type vibration flow plate for uniform mixing with heavy oil ash powders that are input into primarily dried low grade coal to improve drying efficiency. The vibration flow plate, which uniformly mixes the low grade coal and the heavy oil ash powders with each other, has an inherent problem in that because drying steam for drying coals is not uniformly sprayed onto surfaces of the coals, drying efficiency may be reduced.

### DISCLOSURE

### Technical Problem

The present invention is conceived to solve the above-described problems, and an aspect of the present invention is to effectively dry coals by reheat steam that is sprayed to the coals, by reducing loads and, at the same time, uniformly dispersing and flatly transferring the coals while piles of the coals input into a dryer pass through a multi-stage pulverizer, in an apparatus that dries coals by using reheat steam while the coal used as fuel of the thermal power plant is transferred to a dryer.

Further, another aspect of the present invention is to reduce a use amount of fuel by improving combustion efficiency of a boiler of a thermal power plant by increasing a caloric value of coals by maintaining a proper water content due to effective drying of the coals.

Further, yet another aspect of the present invention is to provide a drying technology that may prevent an environment problem resulting from incomplete combustion of coals by adjusting moisture contained in the coals and a technology that may be applied to a thermal power plant.

### Technical Solution

To achieve the above objects, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: a column-shaped body that is installed on surfaces of the plurality of first transfer plates and second transfer plates, which faces an upper side, at a specific interval; a division boss that protrudes from a central portion of a front surface of the body to divide and disperse a central portion of piles of coals input from a fixed quantity coal supplier onto the surfaces of the first transfer plates and the second transfer plates, which face an upper side, into left and right parts; and a pair of fixing members that are fixed at upper ends of the first guide rails and the second guide rails that horizontally support the first transfer plates and at upper ends of the third guide rails and the fourth guide rails that horizontally support the second transfer plates to fixedly support opposite ends of the body, wherein the piles of the coals that are transferred on the surfaces of the first transfer plates and the second transfer plates, which face an upper side, are flattened at a specific height so that reheat steam sprayed while passing through the first transfer plates and the second transfer plates uniformly comes into contact with surfaces of coal particles.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein first transfer rollers are hinge-coupled to between centers of opposite sides of each first transfer plate and the first chains, respectively, first auxiliary rollers are hinge-coupled to side surfaces of the first transfer plate on left and right sides of the first transfer rollers, respectively, second transfer rollers are hinge-coupled to between centers of opposite sides of each second transfer plate and the second chains, respectively, second auxiliary rollers are hinge-coupled to side surfaces of the second transfer plate on left and right sides of the second transfer rollers, respectively, first guide bars that unidirectionally rotate and upwardly support first lower transfer plates separated from the second guide rails are installed from an upper side via a lateral side to a lower side of the first driving sprockets, second guide bars that unidirectionally rotate and downwardly support first upper transfer plates separated from the first guide rails are installed from a lower side via a lateral side to an upper side of the first driven sprockets, third guide bars that unidirectionally rotate and upwardly support second lower transfer plates separated from the fourth guide rails are installed from an upper side via a lateral side to a lower side of the second driving sprockets, fourth guide bars that unidirectionally rotate and downwardly support second upper transfer plates separated from the third guide rails are installed from a lower side via a lateral side to an upper side of the second driven sprockets, a fixed quantity coal supplier that supplies coals to surfaces of the first transfer plates, which face an upper side, at a fixed quantity is included, and coals that are primarily dried by the first coal dryer are input into the second coal dryer to be secondarily dried, and the dispersing and flattening apparatus including: a column-shaped body that is installed on surfaces of the plurality of first transfer plates and second transfer plates, which faces an upper side, at a specific interval; a division boss that protrudes from a central portion of a front surface of the body to divide and disperse a central portion of piles of coals input from the fixed quantity coal supplier to the surfaces of the first transfer plates and the second transfer plates, which face an upper side, into left and right parts; and a pair of fixing members that are fixed at upper ends of the first guide rails and the second guide rails that horizontally support the first transfer plates and at upper ends of the third guide rails and the fourth guide rails that horizontally support the second transfer plates to fixedly support opposite ends of the body, wherein the piles of the coals that are transferred on the surfaces of the first transfer plates and the second transfer plates, which face an upper side, are flattened at a specific height so that reheat steam sprayed while passing through the first transfer plates and the second transfer plates uniformly comes into contact with surfaces of coal particles.

Further, in the present invention, bodies having division bosses formed therein may be fixedly installed at front ends of the first flue gas chamber, the second flue gas chamber, the third flue gas chamber and the fourth flue gas chamber, respectively.

Further, in the present invention, a bottom surface of the body may have a shape of which a thickness becomes thicker as it goes from an end of a blade of the division boss to a rear surface of the body and which is inclined at a specific slope.

Further, in the present invention, a plurality of wedges may be spaced apart from each other at a specific interval to protrude from the bottom surface of the body.

Further, in the present invention, the bottom surface of the body may have a shape of which a thickness becomes thicker as it goes from the end of the blade of the division boss to the rear surface of the body and which has inclined surfaces inclined at a specific slope and the plurality of wedges may be spaced apart from each other at a specific interval to protrude from the bottom surface of the body.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: a column-shaped body that is installed on surfaces of the plurality of first transfer plates and second transfer plates, which face an upper side, at a specific interval; a division boss that protrudes from a central portion of a front surface of the body to divide and disperse a central portion of piles of coals input from a fixed quantity coal supplier to the surfaces of the first transfer plates and the second transfer plates, which face an upper side, into left and right parts; a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below; and a pair of fixing members that are fixed at upper ends of the first guide rails and the second guide rails that horizontally support the first transfer plates and at upper ends of the third guide rails and the fourth guide rails that horizontally support the second transfer plates to fixedly support opposite ends of the body, wherein piles of coals that are transferred on the surfaces of the first transfer plates and the second transfer plates, which face an upper side, are flattened at a specific height so that reheat steam sprayed while passing through the first transfer plates and the second transfer plates uniformly comes into contact with surfaces of coal particles.

Further, in the present invention, the dispersion boss may have a second intersection line in which the opposite inclined surfaces of the dispersion boss meet each other, a third intersection line in which a side surface of the division boss and the inclined surfaces of the dispersion boss meet each other, a fourth intersection line corresponding to the blade, in which a bottom surface and the edge of the dispersion boss meet each other, a first intersection point in which the second intersection line and the third intersection line meet each other, a second intersection point in which the second intersection line and the fourth intersection line meet each other, and a third intersection point in which the third intersection line and the fourth intersection line meet each other.

Further, in the present invention, the dispersion boss may have a second intersection line in which the opposite inclined surfaces of the dispersion boss meet each other, a third intersection line in which a side surface of the division boss and the inclined surfaces of the dispersion boss meet each other, a fourth intersection line corresponding to the blade, in which a bottom surface and the edge of the dispersion boss meet each other, a fifth intersection line in which side surfaces and the body of the dispersion boss meet each other, a first intersection point in which the second intersection line and the third intersection line meet each other, a second intersection point in which the second intersection line and the fourth intersection line meet each other, a third intersection line in which the fourth intersection line and the fifth intersection line meet each other, and a fourth intersection point in which the third intersection line and the fifth intersection line meet each other, wherein the third intersection line and the fourth intersection line may be parallel to each other side by side.

Further, in the present invention, a plurality of dispersion bosses may be vertically formed on side surfaces of the division boss.

Further, in the present invention, bodies to which division bosses having dispersion bosses formed therein are integrally coupled may be fixedly installed at front ends of the first flue gas chamber, the second flue gas chamber, the third flue gas chamber and the fourth flue gas chamber, respectively.

Further, in the present invention, a bottom surface of the body may have a shape of which a thickness becomes thicker as it goes from the second intersection point of the division boss to a rear surface of the body and which is inclined at a specific slope.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including a plurality of flatteners, each of which includes a column-shaped body, a division boss that protrudes from a central portion of a front surface of the body to divide and disperse a central portion of piles of input coals into left and right parts, and a pair of fixing members that fixedly support opposite ends of the body, wherein the plurality of flatteners are installed at a specific interval such that a preceding flattener is installed to have a predetermined-height step from the surfaces of the first transfer plates to be spaced apart from a following flattener such that they become lower as they go from front to rear, and the plurality of flatteners reduce loads of piles of transferred coals by flattening the piles of the coals transferred on the surfaces of the first transfer plates, which face an upper side, such that the piles of the coals become gradually lower at a specific height interval, and allow reheat steam sprayed while passing through the first transfer plates to uniformly come into contact with surfaces of coal particles.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein first transfer rollers are hinge-coupled to between centers of opposite sides of each first transfer plate and the first chains, respectively, first auxiliary rollers are hinge-coupled to side surfaces of the first transfer plate on left and right sides of the first transfer rollers, respectively, second transfer rollers are hinge-coupled to between centers of opposite sides of each second transfer plate and the second chains, respectively, second auxiliary rollers are hinge-coupled to side surfaces of the second transfer plate on left and right sides of the second transfer rollers, respectively, first guide bars that unidirectionally rotate and upwardly support first lower transfer plates separated from the second guide rails are installed from an upper side via a lateral side to a lower side of the first driving sprockets, second guide bars that unidirectionally rotate and downwardly support first upper transfer plates separated from the first guide rails are installed from a lower side via a lateral side to an upper side of the first driven sprockets, third guide bars that unidirectionally rotate and upwardly support second lower transfer plates separated from the fourth guide rails are installed from an upper side via a lateral side to a lower side of the second driving sprockets, fourth guide bars that unidirectionally rotate and downwardly support second upper transfer plates separated from the third guide rails are installed from a lower side via a lateral side to an upper side of the second driven sprockets, a fixed quantity coal supplier that supplies coals to surfaces of the first transfer plates, which face an upper side, at a fixed quantity is included, and coals that are primarily dried by the first coal dryer are input into the second coal dryer to be secondarily dried, and the dispersing and flattening apparatus including a plurality of flatteners, each of which includes a column-shaped body, a division boss that protrudes from a central portion of a front surface of the body to divide and disperse a central portion of piles of input coals into left and right parts, and a pair of fixing members that fixedly support opposite ends of the body, wherein the plurality of flatteners are installed at a specific interval such that a preceding flattener is installed to have a predetermined-height step from the surfaces of the first transfer plates to be spaced apart from a following flattener such that they become lower as they go from front to rear, and the plurality of flatteners reduce loads of piles of transferred coals by flattening the piles of the coals transferred on the surfaces of the first transfer plates, which face an upper side, such that the piles of the coals become gradually lower at a specific height interval, and allow reheat steam sprayed while passing through the first transfer plates to uniformly come into contact with surfaces of coal particles.

Further, in the present invention, the flatteners may include a first flattener to a fourth flattener.

Further, in the present invention, through-holes may be formed at left and right sides of the bodies of the second flattener to the fourth flattener, respectively.

Further, in the present invention, the plurality of flatteners may be installed at front ends of or inside the first flue gas chamber, the second flue gas chamber, the third flue gas chamber and the fourth flue gas chamber, respectively.

Further, in the present invention, each flattener may further include a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: first and second dispersion flatteners, each of which includes a column-shaped body, a division boss that protrudes from a central portion of a front surface of the body, a fixing shaft that is fixed to an upper central portion of a flat surface of the body, a restoration member that is coupled between the fixing shaft and the body to horizontally and elastically support the body with respect to the fixing shaft, and a fixing member that fixedly supports an upper end of the fixing shaft; a flattener that includes a column-shaped body, a division boss that protrudes from a central portion of a front surface of the body, and a pair of fixing members that fixedly support opposite ends of the body; and a pair of transportation coal guide plates that are installed between the first dispersion flattener and the second dispersion flattener and between the second dispersion flattener and the flattener toward insides of the first transfer plates at a specific angle and are located on surfaces of the first transfer plates, and upper ends of which are fixedly supported by support members, wherein the first dispersion flattener, the second dispersion flattener and the flattener are installed at a specific interval to have a predetermined-height step from the surfaces of the first transfer plates as they go from front to rear, and the first dispersion flattener and the second dispersion flattener disperse piles of coals transferred on the surfaces of the first transfer plates, which face an upper side, such that the piles of the coals are not biased to any one side, and the piles of the transferred coals are flattened to become lower by a predetermined-height difference while passing through the first dispersion flattener, the second dispersion flattener and the flattener so that loads of the piles of the transferred coals are flattened and the reheat steam sprayed while passing through the first transfer plates uniformly comes into contact with surfaces of coal particles.

Further, in the present invention, a pair of transportation coal guide plates may be installed in front of the first dispersion flattener.

Further, in the present invention, the first dispersion flattener, the second dispersion flattener, the flattener and the transportation coal guide plates between the first dispersion flattener and the second dispersion flattener and between the second dispersion flattener and the flattener may be installed at front ends of or inside the first flue gas chamber, the second flue gas chamber, the third flue gas chamber and the fourth flue gas chamber, respectively.

Further, in the present invention, each of the first dispersion flattener, the second dispersion flattener and the flattener may further include a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: sorters, each of which includes a rising plate that has a slope that rises at a specific angle as it goes from front to rear; a plurality of first through-holes that are vertically formed in the rising plate at a specific interval to have a specific length; a lowering plate that is bonded to an end of the rising plate and has a slope that is lowered at a specific angle as it rearward goes; and a pair of fixing members that fixedly support the rising plate and the lowering plate that are bonded to each other, wherein one or more sorters are installed at a specific interval and allow reheat steam sprayed while passing through the first transfer plates to uniformly come into contact with surfaces of coal particles through sorting that horizontally disperses a density of piles of coals transferred on surfaces of the first transfer plates, which face an upper side, and equalizes the density.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein first transfer rollers are hinge-coupled to between centers of opposite sides of each first transfer plate and the first chains, respectively, first auxiliary rollers are hinge-coupled to side surfaces of the first transfer plate on left and right sides of the first transfer rollers, respectively, second transfer rollers are hinge-coupled to between centers of opposite sides of each second transfer plate and the second chains, respectively, second auxiliary rollers are hinge-coupled coupled to side surfaces of the second transfer plate on left and right sides of the second transfer rollers, respectively, first guide bars that unidirectionally rotate and upwardly support first lower transfer plates separated from the second guide rails are installed from an upper side via a lateral side to a lower side of the first driving sprockets, second guide bars that unidirectionally rotate and downwardly support first upper transfer plates separated from the first guide rails are installed from a lower side via a lateral side to an upper side of the first driven sprockets, third guide bars that unidirectionally rotate and upwardly support second lower transfer plates separated from the fourth guide rails are installed from an upper side via a lateral side to a lower side of the second driving sprockets, fourth guide bars that unidirectionally rotate and downwardly support second upper transfer plates separated from the third guide rails are installed from a lower side via a lateral side to an upper side of the second driven sprockets, a fixed quantity coal supplier that supplies coals to surfaces of the first transfer plates, which face an upper side, at a fixed quantity is included, and coals that are primarily dried by the first coal dryer are input into the second coal dryer to be secondarily dried, and the dispersing and flattening apparatus including sorters, each of which includes a rising plate that has a slope that rises at a specific angle as it goes from front to rear; a plurality of first through-holes that are vertically formed in the rising plate at a specific interval to have a specific length; a lowering plate that is bonded to an end of the rising plate and has a slope that is lowered at a specific angle as it rearward goes; and a pair of fixing members that fixedly support the rising plate and the lowering plate that are bonded to each other, wherein one or more sorters are installed at a specific interval and allow reheat steam sprayed while passing through the first transfer plates to uniformly come into contact with surfaces of coal particles through sorting that horizontally disperses a density of piles of coals transferred on surfaces of the first transfer plates, which face an upper side, and uniformly equalizes the density.

Further, in the present invention, one or more sorters may be installed at front ends of or inside the first flue gas chamber, the second flue gas chamber, the third flue gas chamber and the fourth flue gas chamber, respectively, or may be installed inside the first flue gas chamber, the second flue gas chamber, the third flue gas chamber and the fourth flue gas chamber, respectively.

Further, in the present invention, a plurality of second through-holes may be horizontally formed in the lowering plate at a specific interval to have a specific width.

Further, in the present invention, a flattening member having elasticity may be coupled to a longitudinal cross-section of the lowering plate.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: first and second sorters, each of which includes a rising plate that has a slope that rises at a specific angle as it goes from front to rear, a plurality of first through-holes that are vertically formed in the rising plate at a specific interval to have a specific length, a lowering plate that is bonded to an end of the rising plate and has a slope that is lowered at a specific angle as it rearward goes, and fixing members that fixedly support the rising plate and the lowering plate that are bonded to each other; and first and second flatteners, each of which includes a column-shaped body, a division boss that protrudes from a central portion of a front surface of the body, and a pair of fixing members that fixedly support opposite ends of the body, wherein the first flattener is installed between the first sorter and the second sorter and the second flattener is installed on a rear side of the second sorter, wherein the first sorter, the first flattener, the second sorter, and the second flattener are installed to have a predetermined height step from surfaces of the first transfer plates such that they become lower as they go from front to rear, the first sorter and the second sorter performs sorting such that a density of piles of coals transferred on the surfaces of the first transfer plates is horizontally dispersed and is uniformly equalized, the first flattener and the second flattener flatten the piles of the coals having passed through the sorters, respectively, and the piles of the coals are flattened to become gradually lower by a predetermined height difference while passing through the first sorter, the first flattener, the second sorter and the second flattener, so that a load of the transferred piles of the coals are reduced and reheat steam sprayed while passing through the first transfer plates uniformly comes into contact with surfaces of coal particles.

Further, in the present invention, the the first and second sorters and the first and second flatteners may be installed at front ends of or inside the first flue gas chamber, the second flue gas chamber, the third flue gas chamber and the fourth flue gas chamber, respectively.

Further, in the present invention, each of the first flattener and the second dispersion flattener may further include a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below.

Further, in the present invention, a brush having a plurality of unevennesses that are formed vertically rearward may be installed on a bottom surface of the sorter, on which the rising plate and the lowering plate are bonded to each other.

Further, in the present invention, a plurality of second through-holes may be horizontally formed in the lowering plate at a specific interval to have a specific width.

Further, in the present invention, a flattening member having elasticity may be coupled to a longitudinal cross-section of the lowering plate.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: a first flattener that uniformly disperses and flattens piles of coals that fall onto and are transferred on surfaces of the first upper transfer plates, which face an upper side; a second flattener that uniformly disperses and flattens piles of coals that fall onto and are transferred on surfaces of the first lower transfer plates, which face an upper side; a third flattener that uniformly disperses and flattens piles of coals that fall onto and are transferred on surfaces of the second upper transfer plates, which face an upper side; and a fourth flattener that uniformly disperses and flattens piles of coals that fall onto and are transferred on surfaces of the second lower transfer plates, which face an upper side, wherein each of a first divider having a plurality of first division bosses that are horizontally spaced apart from each other at a specific interval to protrude from a lower portion of a body, a second divider that has a plurality of second division bosses that are horizontally spaced apart from each other at a specific interval to protrude from a lower portion of a body and is formed on a rear side of the first divider at a specific interval such that the second division bosses are located between the first division bosses that protrude from the first divider and a dispersion flattener that has a division boss protruding from a central portion of a front surface of a column-shaped body and is formed on a rear side of the second divider at a specific interval are installed inside the first flue gas chamber, the second flue gas chamber, the third flue gas chamber and the fourth flue gas chamber, so that while plies of coals that are loaded and transferred on surfaces of the respective transfer plate, which face an upper side, are divided, collected, dispersed and flattened, the coals are dried.

Further, in the present invention, the first divider, the second divider and the dispersion flattener may be fixedly installed in an inner central portion or a rear portion of each flue gas chamber.

Further, the present invention provides a dispersing and flattening apparatus for uniform drying of a transportation coals in a coal dryer using reheat steam, the coal dryer including: a first coal dryer that includes a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and a second coal dryer that includes a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas, wherein coals that are primarily dried by the first coal dryer are input into the second coal dryer to be secondarily dried, and the dispersing and flattening apparatus including: a first flattener that uniformly disperses piles of coals that fall onto and are transferred on surfaces of the first upper transfer plates, which face an upper side; a first residue remover that has a plurality of first rakes horizontally spaced apart from each other at a specific interval to protrude from a lower end of a body and rearward bent and connected second rakes protruding from between the first rakes and is installed to be in contact with surfaces of the first lower transfer plates that escape from the first driven sprockets through rotation; a second flattener that is spaced apart from the first residue remover by a predetermined distance to uniformly disperse and flatten piles of coals that fall onto and are transferred on surfaces of the first lower transfer plates, which face an upper side; a third flattener that uniformly disperses and flattens piles of coals that fall from the first coal dryer onto surfaces of the second upper transfer plates of the second coal dryer, which face an upper side, and are transferred; a second residue remover that has a plurality of first rakes horizontally spaced apart from each other at a specific interval to protrude from a lower end of a body and rearward bent and connected second rakes protruding from between the first rakes and is installed to be in contact with surfaces of the second lower transfer plates that escape from the second driven sprockets through rotation, and a fourth flattener that is spaced apart from the first residue remover by a predetermined interval to uniformly disperse and flatten piles of coals that fall onto and are transferred on surfaces of the second lower transfer plates, which face an upper side, wherein the first residue remover rakes and removes coal residues stuck to surfaces of the first transfer plates by using the elastically contacted rakes and the second residue remover rakes and removes coal residues stuck to surfaces of the second transfer plates by using the elastically contacted rakes.

Further, in the present invention, each of the first flattener to the fourth flattener may include a column-shaped body, a division boss that protrudes from a center of a front surface of the body and a pair of fixing members that fixedly support opposite ends of the body.

### Advantageous Effects

According to the present invention, a coal dryer using reheat steam reduces loads of piles of transferred coals and uniformly disperses and flattens the piles of the coals, to effectively dry coals by depriving moisture contained in the coals by using high-temperature reheat steam sprayed through a plurality of through-holes formed through transfer plates while transferring piles of the coals on the plurality of transfer plates that transfers the coals. Thus, the apparatus allows high-temperature reheat steam to easily come into contact with coals particles, thereby removing moisture remaining inside and outside the coals that are use fuel of a thermal power plant. Accordingly, the apparatus may prevent incomplete combustion of coals, improve caloric values of the coals, reduce discharge of pollution materials, reduces a spontaneous firing rate due to reduction in moisture of the coals and improve stability of coal supply by increasing utilization of low grade coals having low demands. Further, low caloric coals that are cheaper than high caloric coals may be used, fuel costs and production costs may be reduced due to a decrease in an import volume of coals, and a consumption amount of the coals may be relatively reduced, so that discharges of wastes and polluted substances may be reduced and an amount of generated carbon dioxides may be reduced.

### BRIEF DESCRIPTION OF THE DRAWINGS

FIG. 1 is a block diagram illustrating a coal dryer using reheat steam according to an embodiment of the present invention;

FIG. 2 is a schematic view illustrating a front surface of the coal dryer using reheat steam according to the present invention;

FIG. 3 is a schematic view illustrating a side surface the coal dryer using reheat steam according to the present invention;

FIGS. 4 and 5 are perspective views illustrating a main part of the the coal dryer using reheat steam, in which a multi-stage transportation coal flattener is installed according to the present invention;

FIG. 6 is a perspective view illustrating a transportation coal flattener in a coal dryer using reheat steam according to a first embodiment of the present invention;

FIG. 7 is a side view illustrating an operation of the transportation coal flattener according to the present invention;

FIG. 8 is a plan view illustrating the operation of the transportation coal flattener using reheat steam according to the present invention;

FIGS. 9A and 9B are a front view and a rear view illustrating the operation of the transportation coal flattener according to the present invention;

FIG. 10 is a perspective view illustrating a modified example of the transportation coal flattener according to the present invention;

FIG. 11 is a side view of FIG. 10;

FIG. 12 is a perspective view illustrating another modified example of the transportation coal flattener according to the present invention;

FIG. 13 is a side view of FIG. 12;

FIG. 14 is a perspective view illustrating a transportation coal flattener in a coal dryer using reheat steam according to a second embodiment of the present invention;

FIGS. 15A and 15B are a plan view and a side view illustrating an operation of the transportation coal flattener according to the present invention;

FIG. 16 is a side view illustrating detailed configurations of the transportation coal flattener according to the present invention;

FIG. 17 is a perspective view illustrating a modified example of the transportation coal flattener according to the present invention;

FIGS. 18A and 18B are a plan view and a side view illustrating an operation of the transportation coal flattener according to the present invention;

FIG. 19 is a side view illustrating detailed configurations of the transportation coal flattener according to the present invention;

FIGS. 20 and 21 are perspective views illustrating another modified example of the transportation coal flattener according to the present invention;

FIGS. 22 and 23 are perspective views illustrating a main part of a coal dryer using reheat steam, in which a multi-stage transportation coal flattener is installed, according to a third embodiment of the present invention;

FIG. 24 is a perspective view illustrating another modified example of the transportation coal flattener according to the present invention;

FIG. 25 is a side view illustrating the operation of the transportation coal flattener according to the present invention;

FIGS. 26 and 27 are a front view and a plan view illustrating the operation of the transportation coal flattener according to the present invention;

FIGS. 28 and 29 are perspective views illustrating a main part of a coal dryer using reheat steam, in which a plurality of dispersion flatteners and flatteners are installed, according to a fourth embodiment of the present invention;

FIG. 30 is a perspective view illustrating a dispersion flattener according to the present invention;

FIG. 31 is a perspective view illustrating a flattener according to the present invention;

FIG. 32 is a perspective view illustrating a modified example of the dispersion flattener according to the present invention;

FIG. 33 is a perspective view illustrating a modified example of the flattener according to the present invention;

FIG. 34 is a side view illustrating operations of a dispersion flattener and a multi-stage flattener based on a biased load of the transportation coal according to the present invention;

FIGS. 35 and 36 are a front view and a plan view illustrating the operations of the dispersion flattener and the flattener according to the present invention;

FIGS. 37 and 38 are perspective views illustrating a main part of a coal dryer using reheat steam, in which a sorter for uniform drying of the transportation coal is installed, according to a fifth embodiment of the present invention;

FIG. 39 is a perspective view illustrating the sorter according to the present invention;

FIG. 40 is a perspective view illustrating a modified example of the sorter according to the present invention;

FIG. 41 shows a front view, a side view and a plan view illustrating an operation of the sorter for uniform drying of the transportation coal according to the present invention;

FIGS. 42 and 43 are perspective views illustrating a main part of a coal dryer using reheat steam, in which a multi-stage sorter and a flattener for uniform drying of the transportation coal are installed, according to a sixth embodiment of the present invention;

FIG. 44 is a side view illustrating operations of the sorter and the flattener for uniform drying of the transportation coal according to the present invention;

FIGS. 45 and 46 are a front view and a plan view illustrating operations of the sorter and the flattener for uniform drying of the transportation coal according to the present invention, respectively;

FIGS. 47 and 48 are perspective views illustrating a main part of the coal dryer using reheat steam, in which the flattener, a plurality of dividers and the dispersion flattener are installed, according to the sixth embodiment of the present invention;

FIG. 49 is a perspective view illustrating the divider and the dispersion flattener according to the present invention;

FIG. 50 is a plan view illustrating operations of the flattener, the divider and the dispersion flattener according to the present invention;

FIG. 51 is a sectional view illustrating operations of the flattener, the divider and the dispersion flattener according to the present invention;

FIG. 52 is a perspective view illustrating a coal residue remover in a coal dryer using reheat steam according to a seventh embodiment of the present invention;

FIG. 53 is a perspective view illustrating an operation of a remover for removing coal residues stuck to a transfer plate according to the present invention;

FIG. 54 is a sectional view illustrating an operation of a remover for removing coal residues stuck to a transfer plate according to the present invention;

FIGS. 55 and 56 are perspective views illustrating a main part of a coal drying dryer using reheat steam, in which a transportation coal flattener is installed, according to an eighth embodiment of the present invention;

FIG. 57 is an exploded perspective view illustrating a main part of a transportation device in the coal dryer using reheat steam according to the present invention; and

FIGS. 58 and 59 are sectional views illustrating an operation of the transportation device in the coal dryer using reheat steam according to the present invention, respectively.

### BEST MODE FOR THE INVENTION

Hereinafter, a dispersing and flattening apparatus for uniform drying of transportation coals in a coal dryer using reheat steam will be described in detail with reference to the accompanying drawings.

The present invention uniformly disperses and flatly transfers coals while reducing loads of the coals input into a transportation device when the coals are dried while being transferred by using the transportation device such as a conveyor and a transfer plate, so that a drying effect of the coals is improved. In addition, a transportation coal flattener is installed in a coal dryer that dries coals by spraying high-temperature reheat steam while the coals are transferred by inputting the coals from a fixed quantity coal supplier that supplies pulverized coals at a fixed quantity to a transportation device of the coal dryer.

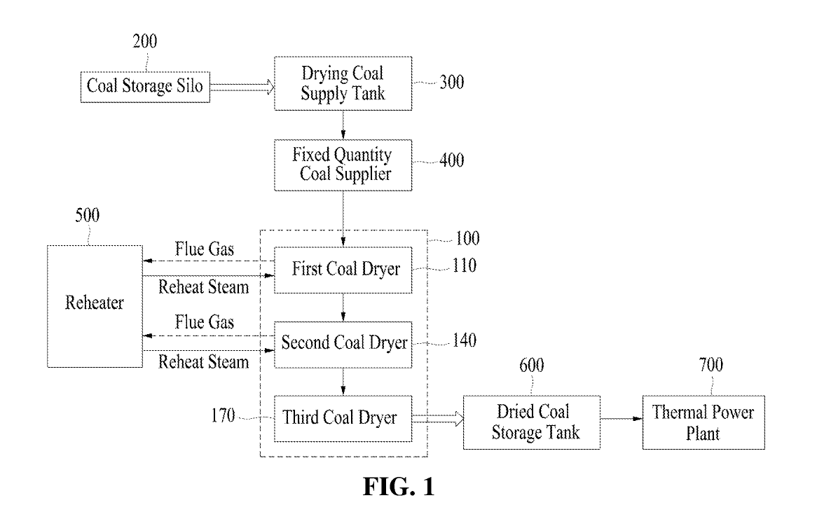

In FIG. 1, a coal storage silo 200 is a place where coals used for fuel of a boiler of a thermal power plant is stored. The coals contains surface moisture and internal moisture. In addition, the coals stored in the coal storage silo 200 are prevented from being scattered, by periodically spraying water. The coals stored in the coal storage silo 200 is transferred to a coal dryer 100 through a transportation means such as a conveyor system. Here, coals in the coal storage silo 200, from which moisture is not removed, may be moved to and stored in a coal supply tank 300 for drying that is connected to the coal dryer. Further, the coals stored in the coal supply tank 300 are supplied from a fixed quantity coal supplier 400 to the coal dryer 100 at a fixed quantity. The coal dryer 100 includes a third coal dryer 170 for drying coals that are discharged through a first coal dryer 110 and a second coal dryer 140 that are installed in a multi-layer. The first coal dryer 110 and the second coal dryer 140 are configured to have approximately the same structure. Coals that are naturally dried via the third coal dryer 170 are temporarily stored in a dry coal storage tank 600 and are then supplied as fuel of a boiler of a thermal power plant 700.

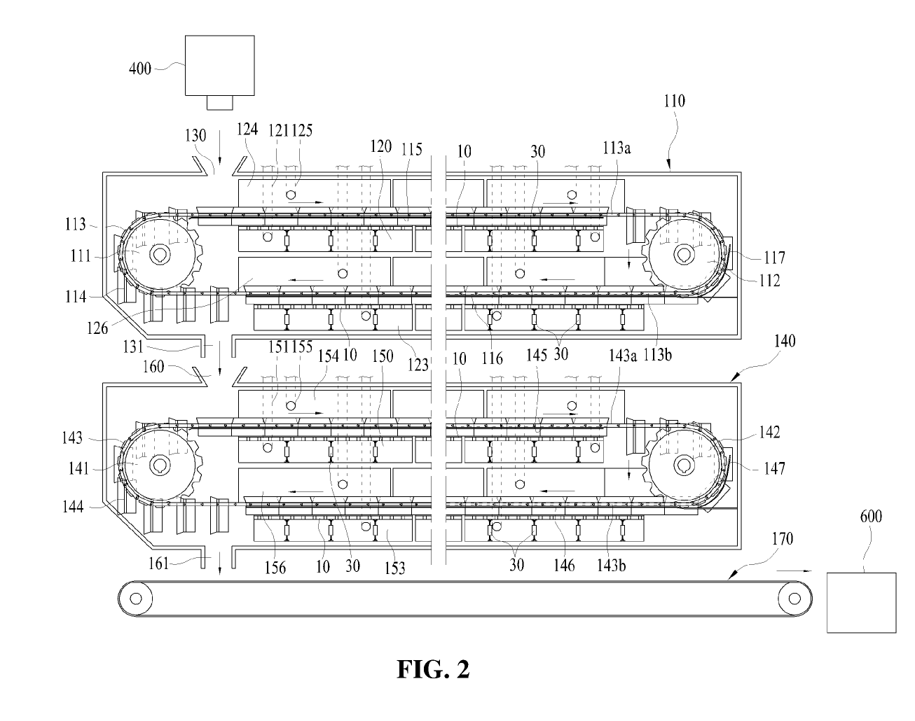

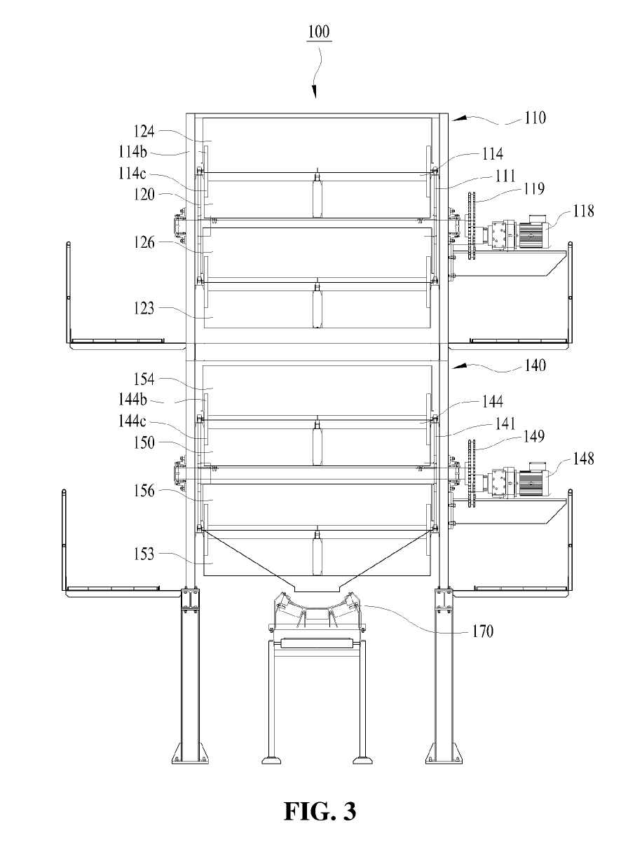

In FIGS. 2 and 3, an example of the coal dryer 100 in which transportation coal flatteners 1 are installed according to the present invention is illustrated. The coal dryer 100 includes a multi-stage dryer that dries coals input from the fixed quantity coal supplier 400, that is, the first coal dryer 110, the second coal dryer 140 that secondarily dries the coals dried by the first coal dryer, and the third coal dryer 170 that supplies the coals dried by the second coal dryer to the dry coal storage tank 600 after naturally drying the coals.

The first coal dryer 110 includes a pair of first driving sprockets 111 and a pair of first driven sprockets 112 that are fastened to each other by first chains 113 to be spaced apart from each other by a specific distance, a plurality of first transfer plates 114 that are hinge-coupled between the first chains 113, a pair of first guide rails 115 that are installed below an second upper chain 143 connected between the first driving sprockets 111 and the first driven sprockets 112 to horizontally support the first transfer plates 114, a pair of second guide rails 116 that are installed below a first lower chain 113 connected between the first driving sprockets 111 and the first driven sprockets 112 to horizontally support the first transfer plates 114, a first steam chamber 120 that is installed below the first upper chain 113 to spray reheat steam supplied by a reheater 500, a second steam chamber 123 that is installed below the first lower chain 113 to spray the reheat steam supplied by the reheater 500, a first flue gas chamber 124 that is installed above the first upper chain 113 to collect flue gas, and a second flue gas chamber 126 that is installed above the first lower chain 113 to collect flue gas.

Further, the second coal dryer 140 includes a pair of second driving sprockets 141 and a pair of second driven sprockets 142 that are fastened to each other by second chains 143 to be spaced apart from each other by a specific distance, a plurality of second transfer plates 144 that are hinge-coupled between the second chains 143, a pair of third guide rails 145 that are installed below a second upper chain 143 connected between the second driving sprockets 141 and the second driven sprockets 142 to horizontally support the second transfer plates 144, a pair of fourth guide rails 146 that are installed below a second lower chain 143 connected between the second driving sprockets 141 and the second driven sprockets 142 to horizontally support the second transfer plates 144, a third steam chamber 150 that is installed below the second upper chain 143 to spray the reheat steam supplied by the reheater 500, a fourth steam chamber 153 that is installed below the second lower chain 143 to spray the reheat steam supplied by the reheater 500, a third flue gas chamber 154 that is installed above the second upper chain 143 to collect flue gas, and a fourth flue gas chamber 156 that is installed above the second lower chain 143 to collect flue gas.

Thus, the transportation coal flatteners 1 are fixedly installed at front ends of the first flue gas chamber 124 and the second flue gas chamber 126 of the first coal dryer 110 and the third flue gas chamber 154 and the fourth flue gas chamber 156 of the second coal dryer 140, respectively.

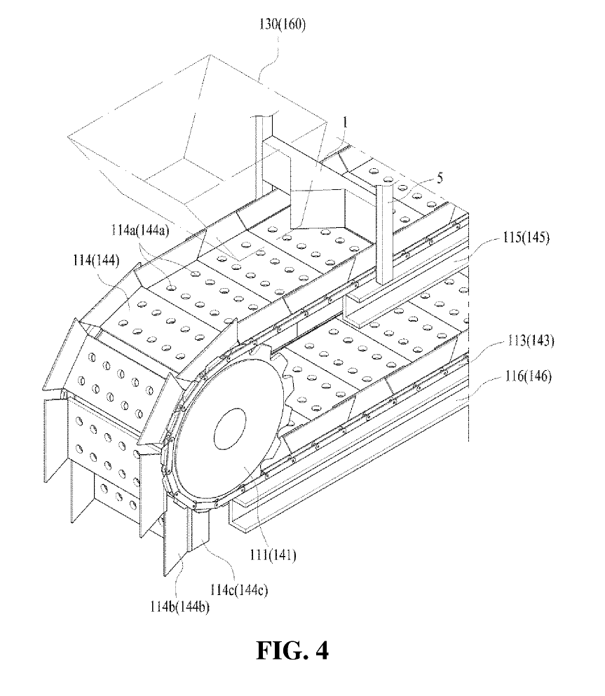

In FIG. 4, the transportation coal flatteners 1 are installed at upper portions of surfaces of the plurality of first transfer plates 114 of the first coal dryer 110, which face an upper side, that is, at a front end of the first flue gas chamber 124 and at upper portions of surfaces of the plurality of second transfer plates 144 of the second coal dryer 140, which face an upper side, that is, at a front end of the third flue gas chamber 154, at a specific interval. In addition, opposite ends of a body 2 of the transportation coal flattener 1 are fixedly supported at upper ends of first guide rails 115 that horizontally support the first transfer plates 114 and at upper ends of the third guide rails 145 that horizontally support the second transfer plates 144, by a pair of fixing members 5, respectively.

Further, in FIG. 5, the transportation coal flatteners 1 are installed at upper portions of surfaces of the plurality of first transfer plates 114 of the first coal dryer 110, which face an upper side, that is, at a front end of the first flue gas chamber 126 and at upper portions of surfaces of the plurality of second transfer plates 144 of the second coal dryer 140, which face an upper side, that is, at a front end of the third flue gas chamber 156, at a specific interval. In addition, the opposite ends of the body 2 of the transportation coal flattener 1 are fixedly supported at an upper end of the second guide rail 116 that horizontally supports the first transfer plates 114 and at an upper end of the fourth guide rail 146 by the pair of fixing members 5, respectively.

Thus, two transportation coal flatteners 1 are installed in the first coal dryer 110 and two transportation coal flatteners 1 are installed in the second coal dryer 140. These are installed at a front end of the first flue gas chamber 124 in which coals are input to upper ends of surfaces of the first transfer plates 114 of the first coal dryer 110 that face an upper side, at a front end of the second flue gas chamber 126 in which coals falls from first upper transfer plates 114 of the first coal dryer 110 to surfaces of first lower transfer plates 114 that face an upper side, at a front end of the third flue gas chamber 154 in which coals falls from the first lower transfer plates 114 of the first coal dryer 110 to surfaces of second upper transfer plates 144 of the second coal dryer 140 that face an upper side and at a front end of the fourth flue gas chamber 156 in which coals falls from the second upper transfer plates 144 of the second coal dryer 140 to surfaces of second lower transfer plates 144 that face an upper side, respectively, to disperse and flatten input and fallen piles of coals to allow reheat steam sprayed while passing through the first transfer plates 114 and the second transfer plates 144 to be uniformly in contact with surfaces of coal particles, thereby more effectively drying the coals.

A plurality of through-holes 114a are formed in the first transfer plates 114 such that the reheat steam sprayed in the first steam chamber 120 and the second steam chamber 123 comes into contact with the coal particles while passing through the first transfer plates 114. Guards 114b having a specific height are installed at left and right sides of top surfaces of the first transfer plates 114 such that the piles of the input coals do not flow down to left sides or right sides of the first transfer plates 114. The guards 114b have an approximately trapezoidal shape, an upper portion of which is wide and a lower portion of which is narrow. Thus, upper portions of the guards 114b of the first transfer plates 114, which are adjacent to each other, overlap each other. Here, it is preferred that the guards 114b of the first transfer plates 114, which are adjacent to each other, are installed in an approximately zigzag direction. Further, shielding plates 114c are installed at left and right sides of bottom surfaces of the first transfer plates 114 such that the reheat steam sprayed in the first steam chamber 120 and the second steam chamber 123 is not dissipated due to spraying thereof to left and right sides of the first steam chamber 120 and the second steam chamber 123, respectively.

Further, a plurality of through-holes 144a are formed in the second transfer plates 144 such that reheat steam sprayed in the third steam chamber 150 and the fourth steam chamber 153 comes into contact with the coal particles while passing through the second transfer plates 144. Guards 144b having a specific height are installed at left and right sides of top surfaces of the second transfer plates 144 such that the piles of the input coals do not flow down to left sides or right sides of the second transfer plates 144. The guides 144b have an approximately trapezoidal shape, an upper portion of which is wide and a lower portion of which is narrow. Thus, upper portions of the guards 144b of the second transfer plates 144, which are adjacent to each other, overlap each other. Here, it is preferred that the guards 144b of the second transfer plates 144, which are adjacent to each other, are installed in an approximately zigzag direction. Further, shielding plates 144c are installed at left and right sides of bottom surfaces of the second transfer plates 144 such that the reheat steam sprayed in the third steam chamber 150 and the fourth steam chamber 153 is not dissipated due to spraying thereof to left and right sides of the third steam chamber 150 and the fourth steam chamber 153, respectively.

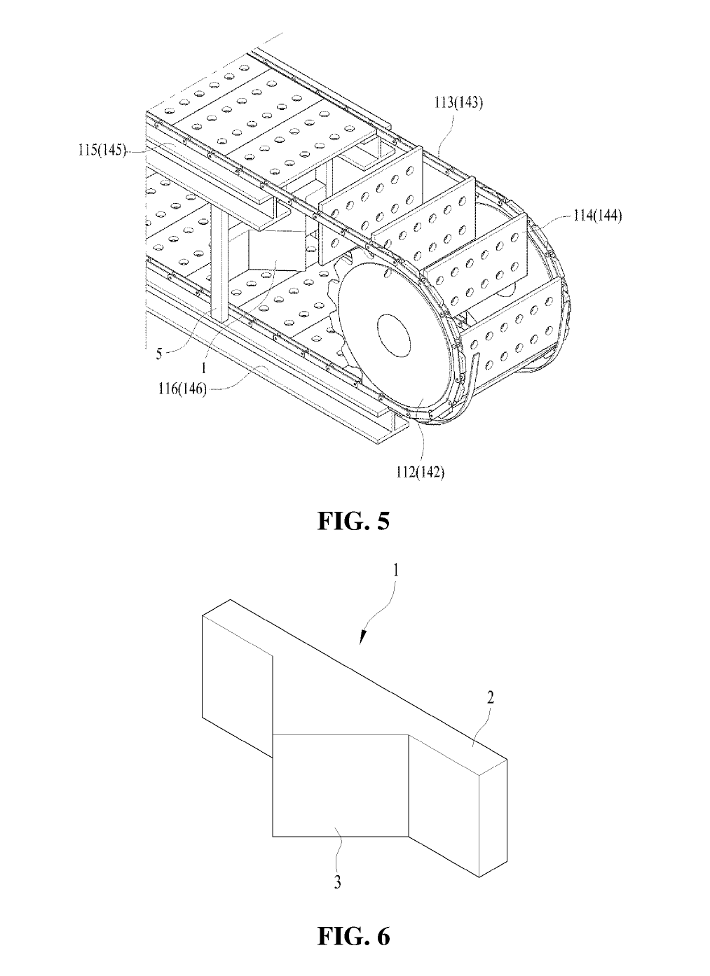

A first embodiment of the dispersing flattening apparatus for uniform drying of transportation coals in a coal dryer using reheat steam according to the present invention will be described in detail with reference to FIGS. 6 to 13.

In FIG. 6, a transportation coal flattener 1 includes a column-shaped body 2. A surface of the body 2, through which coals may be uniformly dispersed on a transportation device, may be formed to have a polygonal shape or an elliptical shape. Further, a division boss 3 that divides and disperses a center of piles of coals input from a fixed quantity coal supplier to a transportation device into left and right parts protrudes from a center of a front surface of the body 2. The division boss 3 has an approximately triangular column shape and has an edge having an intersection line in front of the body 2. Thus, when the piles of the coals comes into contact with the division boss 3, coal particles are divided into opposite left and right sides by the division boss 3. When coals are input onto the transportation device, the coals are stacked in approximately an arc shape. Thus, the piles of the coals that are stacked in an arc shape have a density that is high on a center thereof and becomes lower as it goes to front, rear, left and right sides. Therefore, the division boss 3 performs a function of dividing and dispersing the center of the piles of the coals into left and right parts.

Opposite ends of the body 2 having the division boss 3 that protrudes therefrom are fixedly supported by a pair of fixing members that are fixed to one side of the transportation device. In addition, transportation coal flatteners 1 are installed on the transportation device to be spaced apart from each other at a specific interval. Further, the transportation coal flattener 1 flattens the piles of the coals, which are transferred by the transportation device, at a specific height, and thus, allows reheat steam sprayed while passing through the transportation device to uniformly come into contact with surfaces of the coal particles.

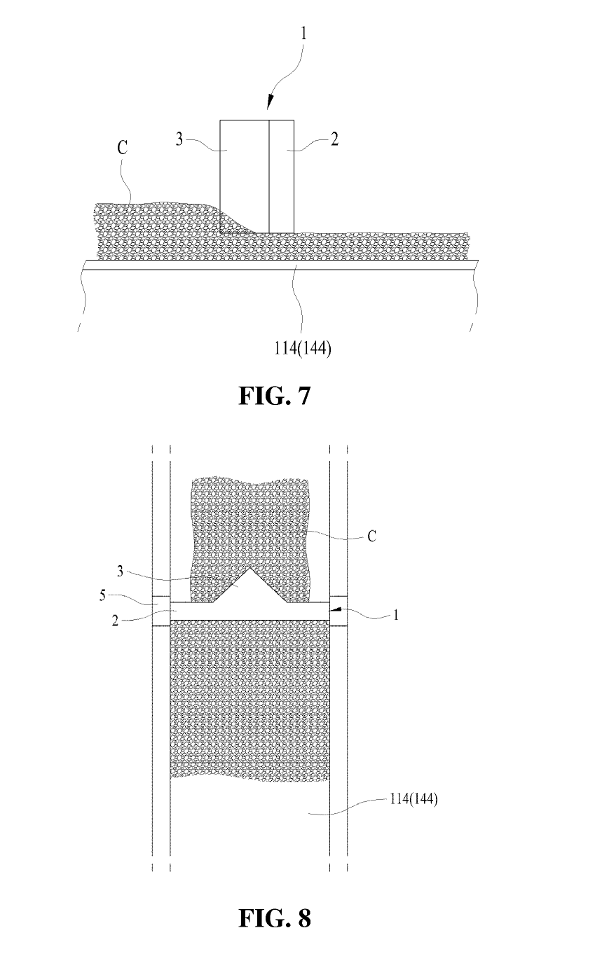

In FIGS. 7 and 8, coals C that are input onto first transfer plates 114 and second transfer plates 144 are flattened while passing through a bottom surface of the flat body 2 after being dispersed into left and right sides while passing through the division boss 3 of the transportation coal flattener 1.

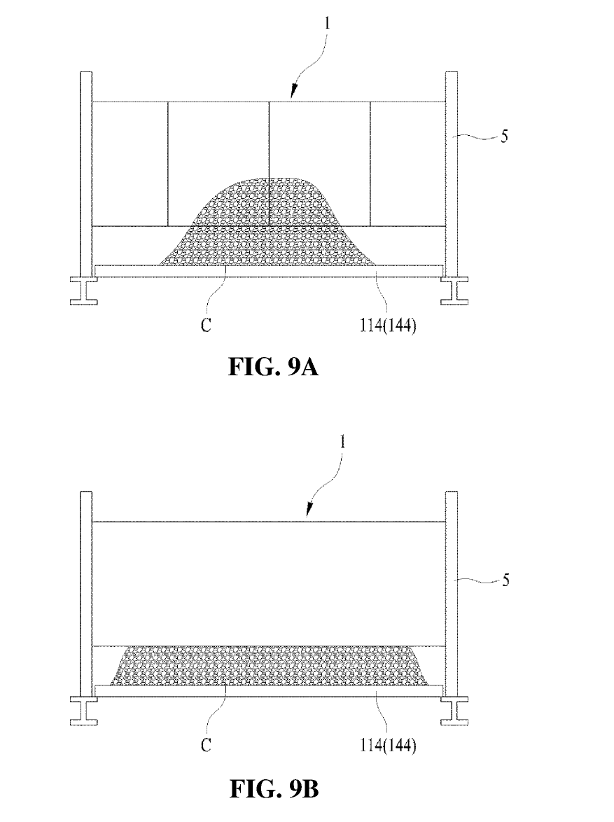

In addition, In FIG. 9A, the coals C that are input or fall onto the first transfer plates 114 and the second transfer plates 144 are stacked approximately in an arc shape. Here, the coals C that are stacked in an arc shape have a density that is high on a center thereof and becomes lower as it goes to front, rear, left and right sides. Thus, when the transferred coals C comes into contact with the division boss 3, a center of the coals C is divided into opposite left and right sides so that coal particles are dispersed. In FIG. 9B, the coals C that are dispersed in this way are flatly arranged on surfaces of the first transfer plates 114 and the second transfer plates 144, which face an upper side, while passing through the transportation coal flattener 1.

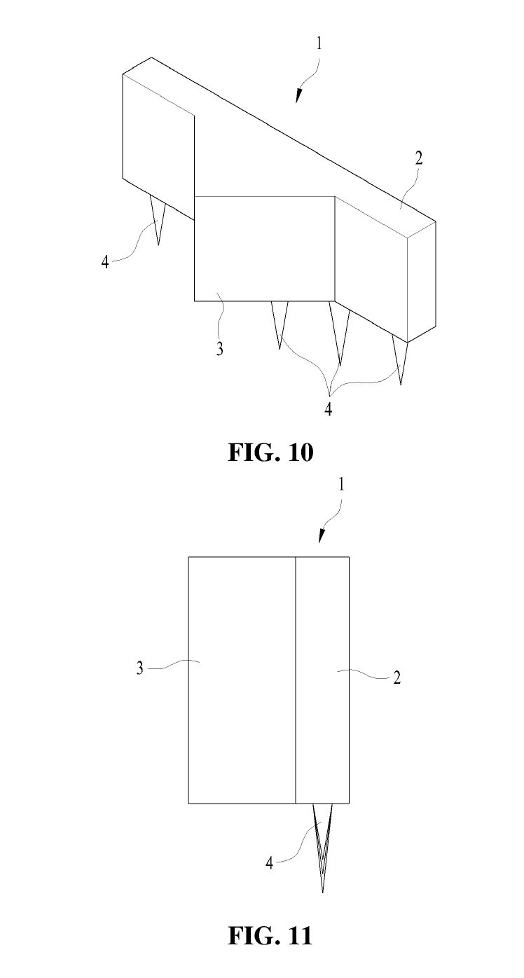

As another embodiment according to the present invention, in FIGS. 10 and 11, the transportation coal flattener 1 has a plurality of wedges 4 that are spaced apart from each other at a specific interval to protrude from a bottom surface of the body 2. That is, after being dispersed into left and right sides while passing through the division boss 1 of the transportation coal flattener 1, the coals C pass through the wedges 4 that protrude from the bottom surface of the body 2 so that the density of the coals 3 are dispersed, and thus more uniform flattening may be achieved.

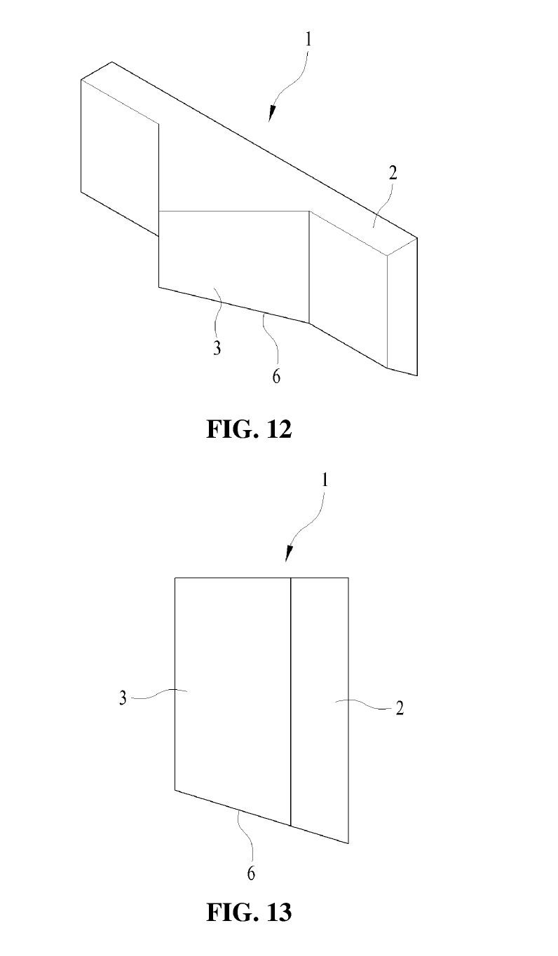

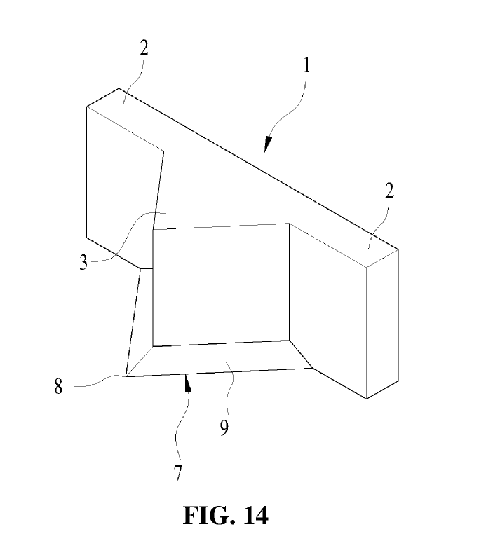

As yet another embodiment according to the present invention, in FIGS. 12 and 13, the bottom surface of the body 2 of the transportation coal flattener 1 is formed in an inclined surface 6 having a shape of which a thickness becomes thicker as it goes from an end of a blade of the division boss 3 to a rear surface of the body 2 and which is inclined at a specific slope. That is, after being dispersed into left and right sides while passing through the division boss 3 of the transportation coal flattener 1, the coals C pass through the division boss 3 and the inclined surface 6 that is inclined on the bottom surface of the body 2 at a specific angle so that the density of the coals 3 are dispersed, and thus uniform flattening may be maintained.

Further, in the present invention, the bottom surface of the body 2 is formed to have a shape of which a thickness becomes thicker as it goes from the end of the blade of the division boss 3 to a rear surface of the body 2 and which is inclined at a specific slope and, at the same time the plurality of wedges 4 are spaced apart from each other at a specific interval to protrude from the bottom surface of the body 2.

Next, a second embodiment of the dispersing flattening apparatus for uniform drying of transportation coals in a coal dryer using reheat steam according to the present invention will be described in detail with reference to FIGS. 14 to 21.

In FIG. 14, a transportation coal flattener 1 includes a column-shaped body 2. A surface of the body 2, through which coals may be uniformly dispersed on a transportation device, may be formed to have a polygonal shape or an elliptical shape. Further, a division boss 3 that divides and disperses a center of piles of coals input from a fixed quantity coal supplier to a transportation device into left and right parts protrudes from a center of a front surface of the body 2. The division boss 3 has an approximately triangular column shape and has an edge having an intersection line in front of the body 2. Thus, when the piles of the coals comes into contact with the division boss 3, coal particles are divided into opposite left and right sides by the division boss 3. When coals are input onto the transportation device, the coals are stacked in approximately an arc shape. Thus, the piles of the coals that are stacked in an arc shape have a density that is high on a center thereof and becomes lower as it goes to front, rear, left and right sides. Therefore, the division boss 3 performs a function of dividing and dispersing the center of the piles of the coals into left and right parts.

Opposite ends of the body 2 having the division boss 3 that protrudes therefrom are fixedly supported by a pair of fixing members that are fixed to one side of the transportation device. In addition, transportation coal flatteners 1 are installed on the transportation device to be spaced apart from each other at a specific interval. Further, the transportation coal flattener 1 flattens the piles of the coals, which are transferred by the transportation device, at a specific height, and thus, allows reheat steam sprayed while passing through the transportation device to uniformly come into contact with surfaces of the coal particles.

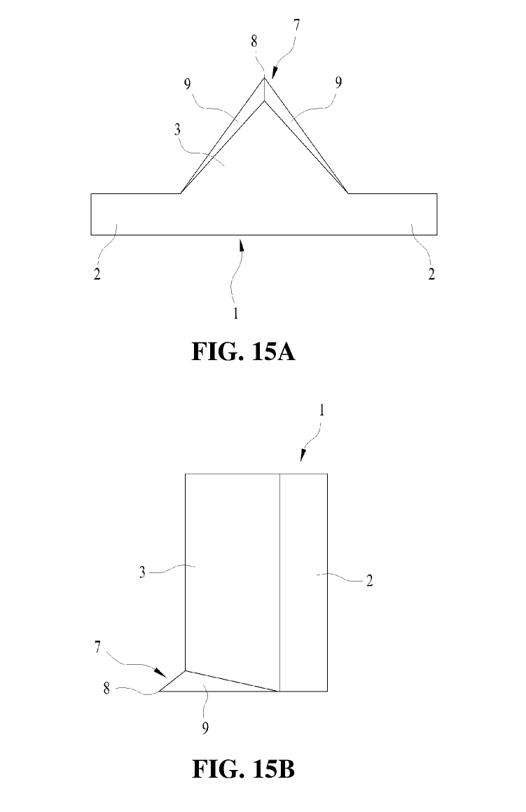

In addition, in FIGS. 15A and 15B, a dispersion boss 7 protrudes from a lower edge, that is, front and opposite sides of the division boss 3. The dispersion boss 7 has an edge 8 that protrudes from a front side of a lower edge of the division boss 3 and a blade 9 that protrudes from the edge 8 to opposite surfaces of the lower edge of the division boss 3. Inclined surfaces having a specific slope, which become wider as they go from above to below, are formed from the edge 8 to the blade 9 of the dispersion boss 7.

The dispersion boss 7 crosses a central portion of the piles of the coals that are transferred by the transportation device, by the edge 8, to divide the central portion having a high density. The dispersion boss 7 allows the coals, which flow down after the piles of the coals divided by the edge 8 and the division boss 3 are dispersed into opposite sides along the division boss 3, to flow down to front sides of the inclined surfaces on opposite sides thereof so as to disperse the piles of the coals at an uniform density and uniformly spread the piles of the coals on a surface of the transportation device.

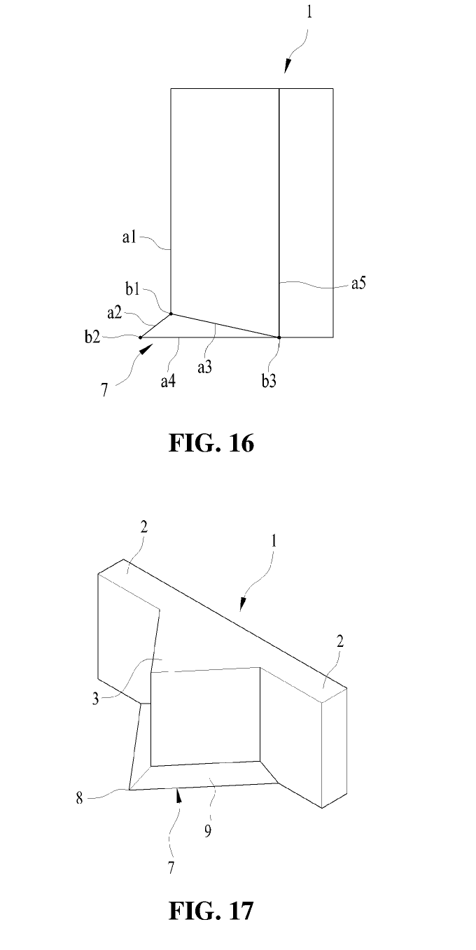

In FIG. 16, the dispersion boss 7 including the edge 8, the blade 9 and the inclined surfaces is illustrated with reference to an intersection line in which a surface and a surface meet each other and an intersection point in which a line and a line meet each other.

That is, a first intersection line a1 is a line in which opposite surfaces of the division boss 3 meet each other on the front surface thereof, a second intersection line a2 is a line in which the opposite inclined surfaces 9 of the dispersion boss 7 meet each other, a third intersection line a3 is a line in which a side surface of the division boss 3 and the inclined surfaces 9 of the dispersion boss 7 meet each other, a fourth intersection line a4 is a line corresponding to a blade 13 in which the bottom surface and the edge of the dispersion boss 7 meet each other, and a fifth intersection line a5 is a line in which the side surface of the division boss 3 and the body 2 meet each other. Further, a first intersection point b1 is a point at which the first intersection line a1 and the second intersection line a2 meet each other, a second intersection point b2 is a point at which the second intersection line a2 and the fourth intersection line a4 meet each other, and a third intersection point b3 is a point at which the third intersection line a3, the fourth intersection line a4 and the fifth intersection line a5 meet each other.

Thus, the dispersion boss 7 that protrudes from a lower edge of the division boss 3 of the flatter 1 corresponds to a three-dimensional portion that is formed by contacting the first intersection point b1 in which the second intersection line a2 and the third intersection line a3 meet each other, the second intersection point b2 in which the second intersection line a2 and the fourth intersection line a4 meet each other and the third intersection point b3 in which the third intersection line a3 and the fourth intersection line a4 meet each other.

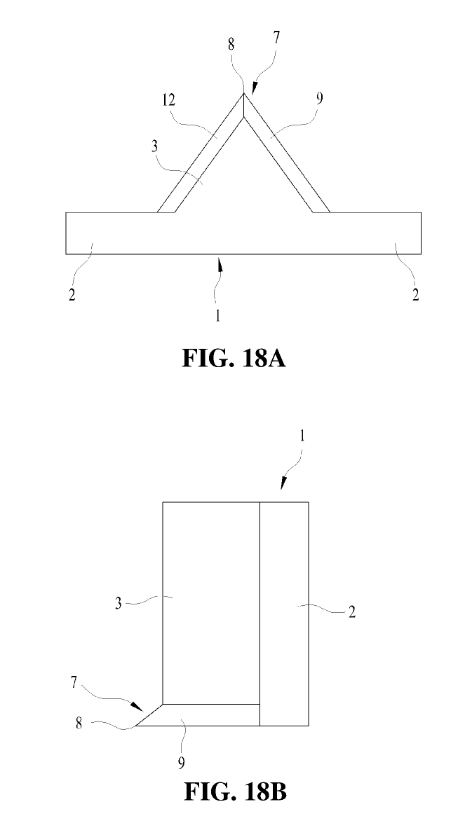

Further, as another modified example of the present invention, in FIGS. 17 and 18, a dispersion boss 7 protrudes from a lower edge, that is, front and opposite sides of the division boss 3. The dispersion boss 7 has an edge 8 that protrudes from a front side of a lower edge of the division boss 3 and a blade 9 that protrudes from the edge 8 to opposite surfaces of the lower edge of the division boss 3. Inclined surfaces having a specific slope, which become wider as they go from the edge 8 to the blade 9 of the dispersion boss 7, are formed. Further, the dispersion boss 7 has inclined surfaces having a specific width, which extend from the edge 8 to the body 2.

The dispersion boss 7 crosses a central portion of the piles of the coals that are transferred by the transportation device, by the edge 8, to divide the central portion having a high density. The dispersion boss 7 allows coals, which flow down after the piles of the coals divided by the edge 8 and the division boss 3 are dispersed into opposite sides along the division boss 3, to flow down to front sides of the inclined surfaces on opposite sides so as to disperse the piles of the coals at a uniform density and uniformly spread the piles of the coals on a surface of the transportation device.

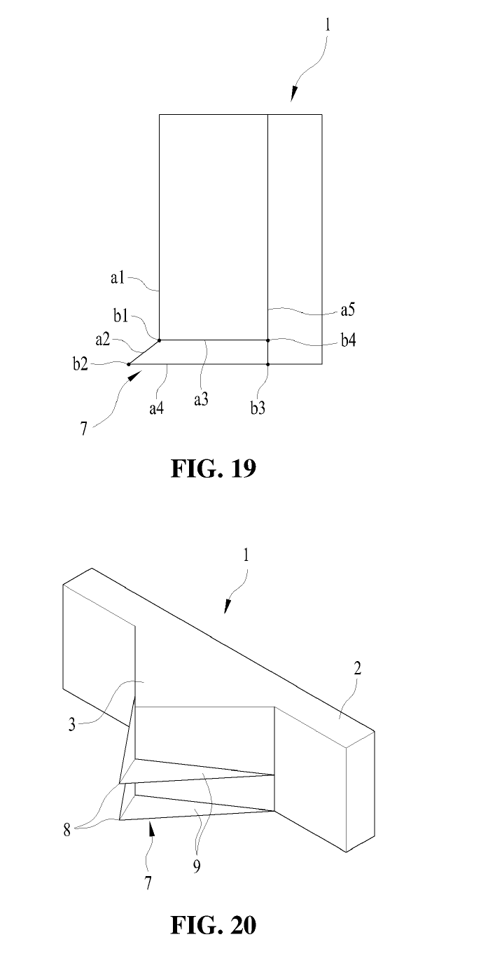

In addition, in FIG. 19, the dispersion boss 7 including the edge 8, the blade 9 and the inclined surfaces is illustrated with reference to an intersection line in which a surface and a surface meet each other and an intersection point in which a line and a line meet each other. That is, the dispersion boss 7 corresponds to a portion where the third intersection line a3 and the fourth intersection line a4 are formed parallel to each other side by side. That is, a first intersection line al is a line in which opposite surfaces of the division boss 3 meet each other on the front surface thereof, a second intersection line a2 is a line in which the opposite inclined surfaces 9 of the dispersion boss 7 meet each other, a third intersection line a3 is a line in which the side surface of the division boss 3 and the inclined surfaces 9 of the dispersion boss 7 meet each other, a fourth intersection line a4 is a line corresponding to a blade 13 in which the bottom surface and the edge of the dispersion boss 7 meet each other, and a fifth intersection line a5 is a line in which a side surface of the division boss 3 and the body 2 meet each other. Further, a first intersection point b1 is a point at which the first intersection line a1 and the second intersection line a2 meet each other, a second intersection point b2 is a point at which the second intersection line a2 and the fourth intersection line a4 meet each other, and a third intersection point b3 is a point at which the fourth intersection line a4 and the fifth intersection line a5 and a fourth intersection point b4 is a point at which the third intersection line a3 and the fifth intersection line a5 meet each other. Here, the third intersection line a3 and the fourth intersection line a4 are parallel to each other side by side.

Thus, the dispersion boss 7 that protrudes from a lower edge of the division boss 3 of the flatter 1 corresponds to a three-dimensional portion that is formed by contacting the first intersection point b1 in which the second intersection line a2 and the third intersection line a3 meet each other, the second intersection point b2 in which the second intersection line a2 and the fourth intersection line a4 meet each other, the third intersection point b3 in which the fourth intersection line a4 and the fifth intersection line a5 meet each other and the fourth intersection point b4 in which the third intersection line a3 and the fifth intersection line a5 meet each other.

Coals C that are input onto surfaces of the first transfer plates 114 and the second transfer plates 144 of the coal dryer are flattened as the coals are divided into left and right sides while passing through the division boss 3 of the transportation coal flattener 1 and the divided coals are uniformly dispersed along the dispersion boss 7 and are then flattened while passing through the flat body 2. In addition, the coals C that are input or fall onto the first transfer plates 114 and the second transfer plates 144 are stacked approximately in an arc shape. Here, the coals C that are stacked in an arc shape have a density that is high on a center thereof and becomes lower as it goes to front, rear, left and right sides. Thus, when the transferred coals C comes into contact with the division boss 3 and the edge 8 of the dispersion boss 7, a center of the coals C is divided into opposite left and right sides so that coal particles are dispersed. Further, the dispersion boss 7 more uniformly disperses the coal particles to make a density of the piles of the coals more uniform. The coals C that are dispersed in this way are flatly arranged on surfaces of the first transfer plates 114 and the second transfer plates 144, which face an upper side, by passing through the transportation coal flattener 1.

As another modified example of the present invention, in FIG. 20, a plurality of dispersion bosses 7 are vertically formed on the side surface of the division boss 3. This is for achieving flattening at a uniform density by more effectively dispersing the coals C that are input onto the surfaces of the first transfer plates 114 and the second transfer plates 144, which face an upper side, by the plurality of dispersion bosses 7 formed on opposite surface of the division boss 3. That is, a center portion of the coals C that are input onto the surfaces of the first transfer plates 114 and the second transfer plates 144, which face an upper side, in an arc shape is divided by first dispersion bosses 7 that are formed on opposite sides of a central portion of the division boss 3 of the flattener 1 and second dispersion bosses 7 that are formed on opposite sides of a lower portion of the division boss 3 and the divided coals C are uniformly dispersed and flattened by edges, blades and inclined surfaces of the first dispersion boss 7 and the second dispersion boss 7. In FIG. 15, the inclined surfaces of each dispersion boss 7 has an approximately triangular shape that is obtained by connecting the first intersection point, the second intersection point and the third intersection point to each other by intersection lines therebetween, when viewed from a side surface.

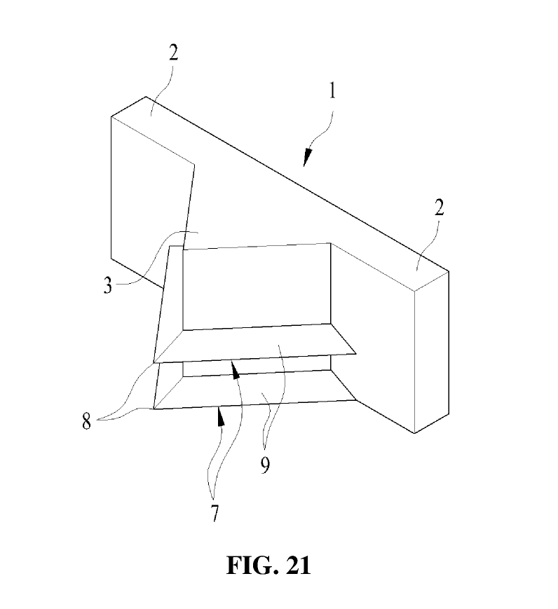

In addition, in FIG. 21, the inclined surfaces of the first dispersion boss 7 and the second dispersion boss 7 have an approximately quadrangular shape that is obtained by connecting the first intersection point, the second intersection point, the third intersection point and the fourth intersection point to each other, when viewed from a side surface.

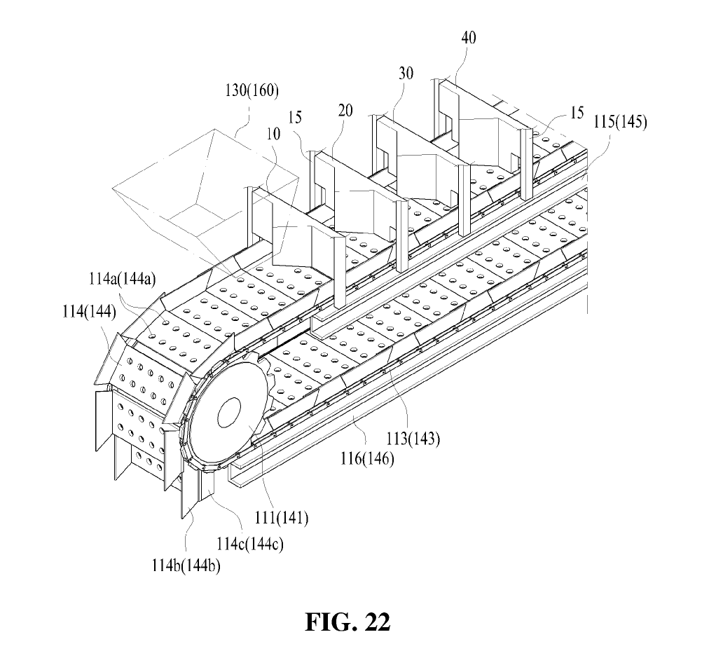

Next, a third embodiment of the dispersing flattening apparatus for uniform drying of transportation coals in a coal dryer using reheat steam according to the present invention will be described in detail with reference to FIGS. 22 to 27.

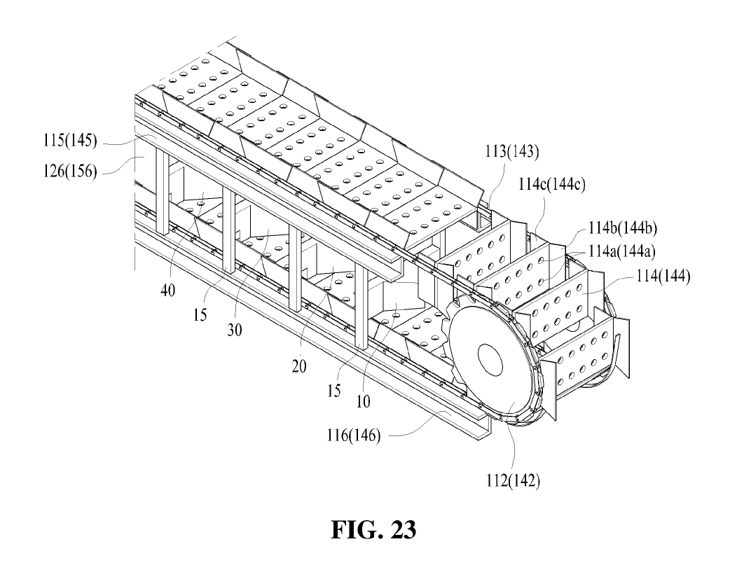

In FIGS. 22 and 23, a plurality of flatteners 10, 20, 30 and 40 are installed at front ends of the first flue gas chamber 124 and the second flue gas chamber 126 to disperse and flatten piles of coals C that fall from the first upper transfer plates 114 onto the surface of the first lower transfer plates 114. Further, the plurality of flatteners 10, 20, 30 and 40 are installed at front ends of the third flue gas chamber 154 and the fourth flue gas chamber 156 to disperse and flatten the transferred piles of the coals C. In addition, the plurality of flatteners 10, 20, 30 and 40 may be also installed inside the first flue gas chamber 124, the second flue gas chamber 126, the third flue gas chamber 154 and the fourth flue gas chamber 156. Thus, the plurality of flatteners 10, 20, 30 and 40 are installed in the first flue gas chamber 124, the second flue gas chamber 126, the third flue gas chamber 154 and the fourth flue gas chamber 156 to disperse and flatten loads of the input and fallen piles of the coals so as to allow reheat steam sprayed while passing through the first transfer plates 114 and the second transfer plates 144 to uniformly come into contact with surfaces of coal particles, thereby more effectively drying the coals.

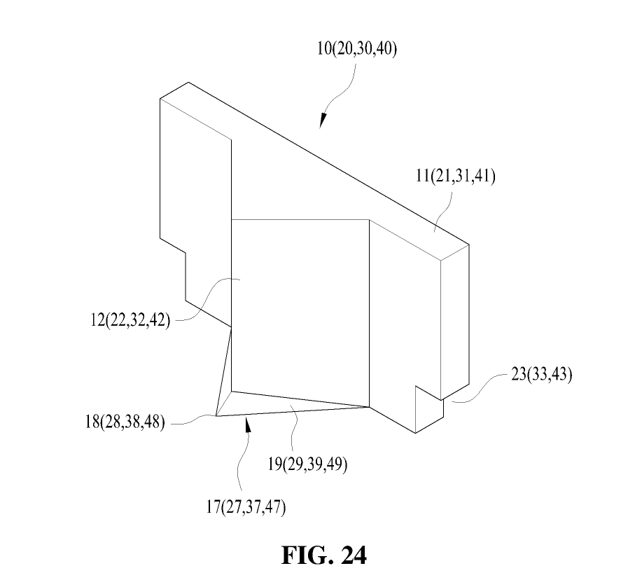

In FIG. 24, each of the flatteners 10, 20, 30 and 40 further has a dispersion boss 7 that has an edge 8 which protrudes from a front side of a lower edge of a division boss and a blade 9 which protrudes from opposite side surfaces of the lower edge of the division boss, and that has inclined surfaces having a specific slope, which become wider as they go from the edge 8 to the blade 9 from above to below.

The dispersion boss 7 has the edge 8 that protrudes from the front side of the lower edge of the division boss 12 and the blade 9 that protrudes from the edge 8 to opposite side surfaces of the lower edge of the division boss 12. Inclined surfaces having a specific slope, which become wider as they go from the edge 8 to the blade 9 of the dispersion boss 7, are formed. The dispersion boss 7 crosses a central portion of the piles of the coals that are transferred by the transportation device, by the edge 8, to divide the central portion having a high density. The dispersion boss 7 allows coals, which flow down after the piles of the coals divided by an edge 11 and the division boss 12 are dispersed into opposite sides along the division boss 12, to flow down to front sides of the inclined surfaces on opposite sides so as to disperse the piles of the coals at a uniform density and uniformly spread the piles of the coals on a surface of the transportation device.

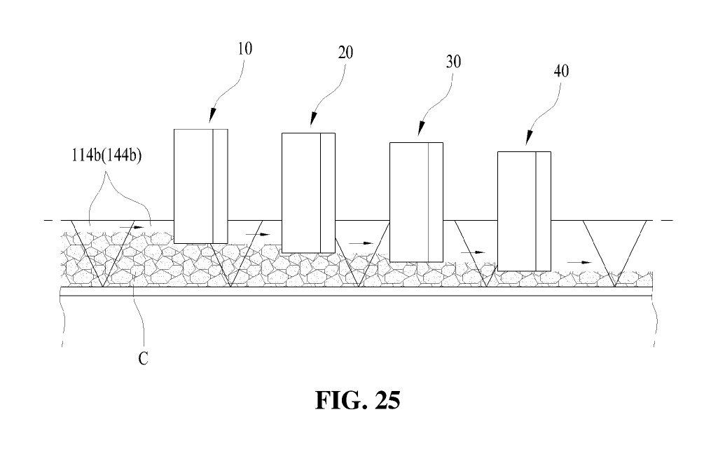

In FIG. 25, the plurality of flatters 10, 20, 30 and 40 flatten the piles of the coals C that are transferred on surfaces of the first transfer plates 114, which faces an upper side, to be increasingly lowered at a specific height interval, so as to reduce loads of the piles of the transferred coals C and allow the reheat steam sprayed while passing through the first transfer plates 114 to uniformly come into contact with surfaces of coal particles as well.

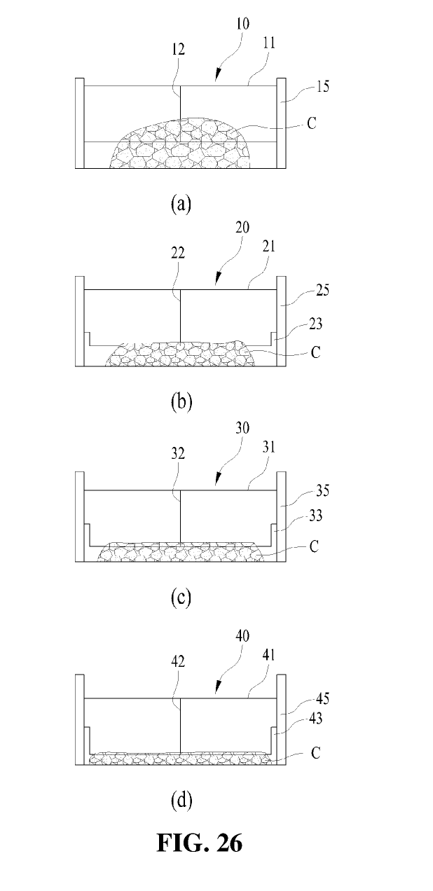

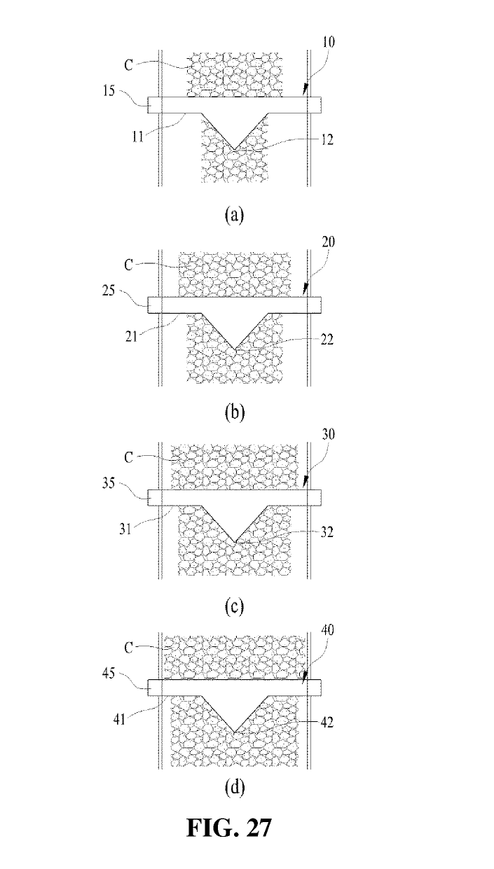

In addition, in FIGS. 26A and 27A, the piles of the coals C that are input from a dust reducer 1 to the surfaces of the first transfer plates 114 and are transferred have an approximately circular arc shape. The piles of the coals C are dispersed into opposite sides by the division boss 12 while an upper portion thereof is flattened, while the piles pass through the first flattener 10. Further, in FIGS. 26B and 27B, the piles of the coals C flattened while passing through the first flattener 10 are dispersed into opposite sides by a division boss 22 while an upper portion thereof is flattened, while the piles pass through the second flattener 20. Further, in FIGS. 26C and 27C, the piles of the coals C flattened while passing through the second flattener 20 are dispersed into opposite sides by a division boss 32 while an upper portion thereof is flattened, while the piles pass through the third flattener 30. Further, in FIGS. 26D and 27D, the piles of the coals C flattened while passing through the third flattener 30 are dispersed into opposite sides by a division boss 42 while an upper portion thereof is flattened, while the piles pass through the fourth flattener 40. Thus, the piles of the coals C having a circular arc shape are flattened to have approximately the same thickness as that of the surfaces of the first transfer plates 114 while passing through the first flattener 10 to the fourth flattener 40. Thus, the piles of the coals C having a specific volume and a specific weight, which are input from the dust reducer 1, are dispersed and flattened in a reduced load while passing through the first flattener 10 to the fourth flattener 40.

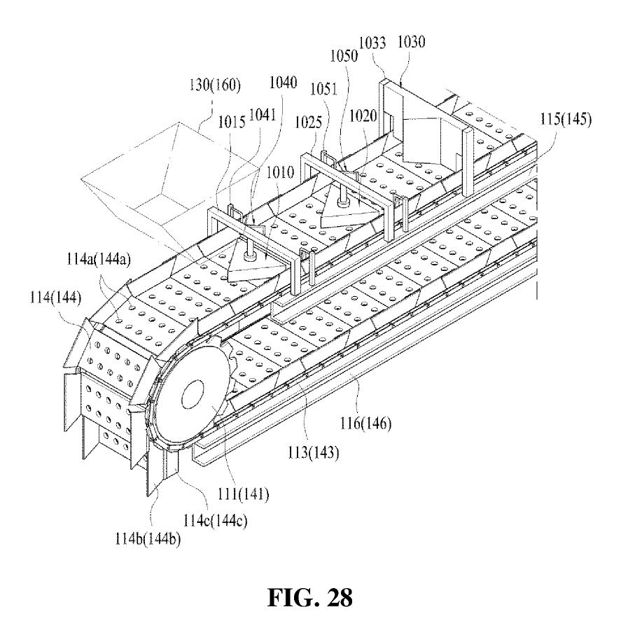

Next, a fourth embodiment of the dispersing flattening apparatus for uniform drying of transportation coals in a coal dryer using reheat steam according to the present invention will be described in detail with reference to FIGS. 28 to 36.

Next, a fourth embodiment of the dispersing flattening apparatus for uniform drying of transportation coals in a coal dryer using reheat steam according to the present invention will be described in detail with reference to FIGS. 28 to 36.

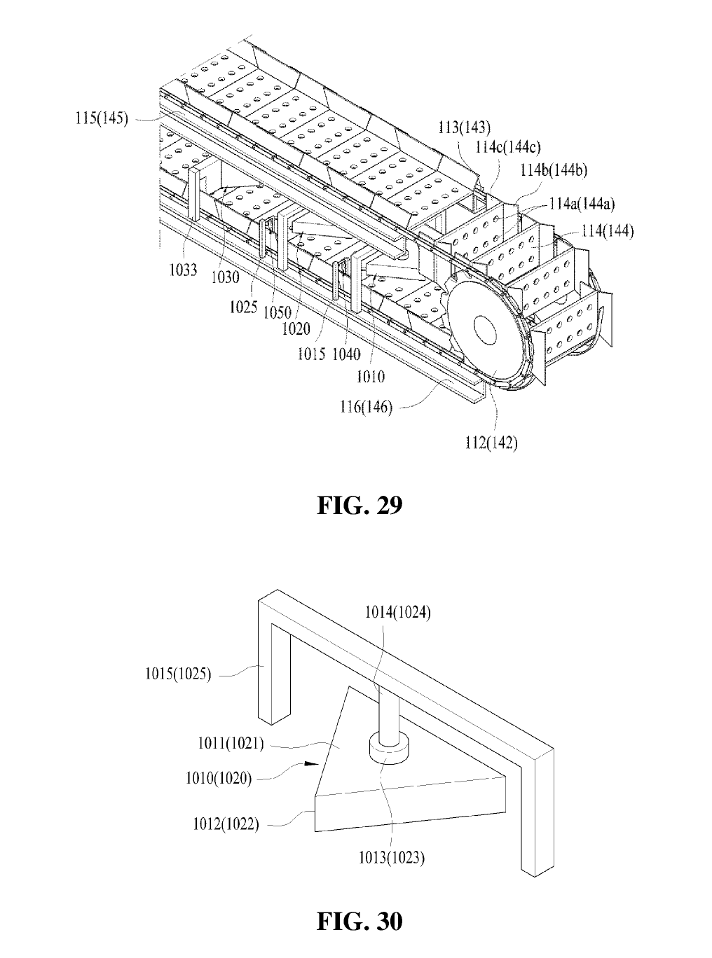

In FIGS. 28 and 29, a first dispersion flattener 1010, a second dispersion flattener 1020 and a flattener 1030 are installed at front ends of the first flue gas chamber 124 and the second flue gas chamber 126 to disperse and flatten piles of coals C that fall from the first upper transfer plates 114 to the surfaces of the first lower transfer plates 114. Further, the first dispersion flattener 1010, the second dispersion flattener 1020 and the flattener 1030 are installed at front ends of the third flue gas chamber 154 and the fourth flue gas chamber 156 to disperse and flatten the transferred piles of the coals C. In addition, the first dispersion flattener 1010, the second dispersion flattener 1020 and the flattener 1030 may be also installed inside the first flue gas chamber 124, the second flue gas chamber 126, the third flue gas chamber 154 and the fourth flue gas chamber 156. Thus, the first dispersion flattener 1010, the second dispersion flattener 1020 and the flattener 1030 are installed in the first flue gas chamber 124, the second flue gas chamber 126, the third flue gas chamber 154 and the fourth flue gas chamber 156 to disperse and flatten loads of the input and fallen piles of the coals so as to allow reheat steam sprayed while passing through the first transfer plates 114 and the second transfer plates 144 to be uniformly in contact with surfaces of coal particles, thereby more effectively drying the coals.

In FIG. 30, the dispersion flattener 1010 includes an approximately triangular column-shaped body 1011 such that a protruding division boss 1012 is formed at a center of a front surface of the body 1011. Further, a fixing shaft 1014 having a specific length is fixed to a center of a upper flat surface of the body 1011 and a restoration member 1013 that horizontally and elastically supports the body 1011 with respect to the fixing shaft 1014 is formed between the fixing shaft 1014 and the body 1011. A spring having elasticity, for example, a compression spring, a leaf spring or the like may be applied to the restoration member 1013. The restoration member 1013 is fixed to the fixing shaft 1014 on one side thereof and is fixed to the body 1011 on the other side thereof so that the body 1011 can be transversely rotated and restored about the fixing shaft 1014. Further, a fixing member 1015 is coupled to an upper end of the fixing shaft 1014 to fixedly support the fixing shaft 1014. Further, the fixing member 1015 is fixedly installed on one side of the transportation device, for example, to the first guide rails 115 to fixedly support the body 1011 via the fixing shaft 1014.

The dispersion flatteners are classified into the first dispersion flattener 1010 and the second dispersion flattener 1020 and the first dispersion flattener 1010 and the second dispersion flattener 1020 are installed on the first transfer plates 114 at a specific interval.

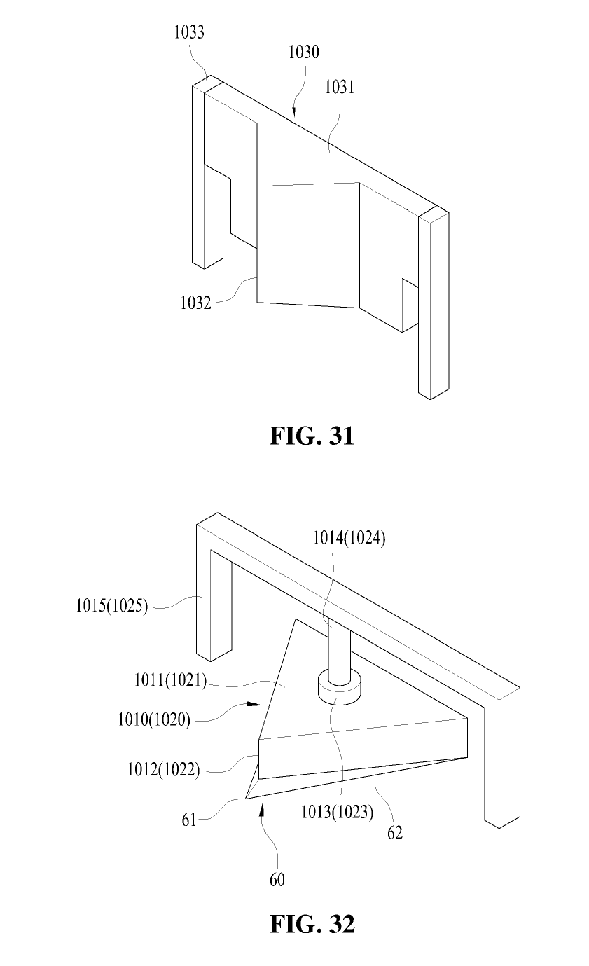

In FIG. 31, the flattener 1030 includes a column-shaped body 1031, a dispersion boss 1032 that protrudes from a center of a front surface of the body, and a pair of fixing members 1033 that fixedly support opposite ends of the body 1031. That is, the flattener 1030 includes a column-shaped body 1031. A surface of the body 1031, through which coals may be uniformly dispersed on the transportation device, may be formed to have a polygonal shape or an elliptical shape. Further, the division boss 1032 that divides and disperses a center of piles of coals transferred after passing through the second dispersion flattener 1020 into left and right parts protrudes from a center of the front surface of the body 1031. The division boss 1032 has an approximately triangular column shape and has an edge having an intersection line in front of the body 1031. Thus, when the piles of the coals come into contact with the division boss 1032, coal particles are divided into opposite left and right sides by the division boss 1032. Thus, the division boss 1032 performs a function of dividing and dispersing the center of the piles of the coals into left and right parts and flattening the piles of the coals as well.

Opposite ends of the body 1031 having the division boss 1032 that protrudes therefrom are fixedly supported by the pair of fixing members 1033 that are fixed to one side of the transportation device. In addition, flatteners 1030 is are installed on the transportation device at a specific interval. Further, the flattener 1030 flattens the piles of the coals, which are transferred by the transportation device, at a specific height, and thus, allows reheat steam sprayed while passing through the transportation device to uniformly come into contact with surfaces of the coal particles.

Pair of transportation coal guide plates 1040 and 1050 are installed toward insides of the first transfer plates 144 at a specific angle such that the piles of the coals that are transferred on surfaces of the first transfer plates 114 are collected on insides, that is, central portion of the surfaces of the first transfer plates 114. The first transportation coal guide plates 1040 are installed between the first dispersion flattener 1010 and the second dispersion flattener 1020, that is, on a rear side of the first dispersion flattener 1010, and the second transportation coal guide plates 1050 are installed between the second dispersion flattener 1020 and the flattener 1030, that is, on a rear side of the second dispersion flattener 1020. The first transportation coal guide plates 1040 and the second transportation coal guide plates 1050 are installed toward the insides of the first transfer plates 114 at a specific angle such that a length of the first transportation coal guide plates 1040 is larger than a length of the second transportation coal guide plate 1050 or an installation angle of the first transportation coal guide plates 1040, which corresponds to a transfer direction of piles of coals, is larger than an installation angle of the second transportation coal guide plates 1050. Upper ends of the first transportation coal guide plates 1040 and the second transportation coal guide plates 1050 are fixedly supported by support members 1041 and 1051 fixed to the first guide rails 115, respectively.

Further, it is also preferred that a pair of transportation coal guide plates are installed in front of the first dispersion flattener 1010 so that flow of the transferred piles of the coals is collected to inner sides of the surfaces of the first transfer plates 114.

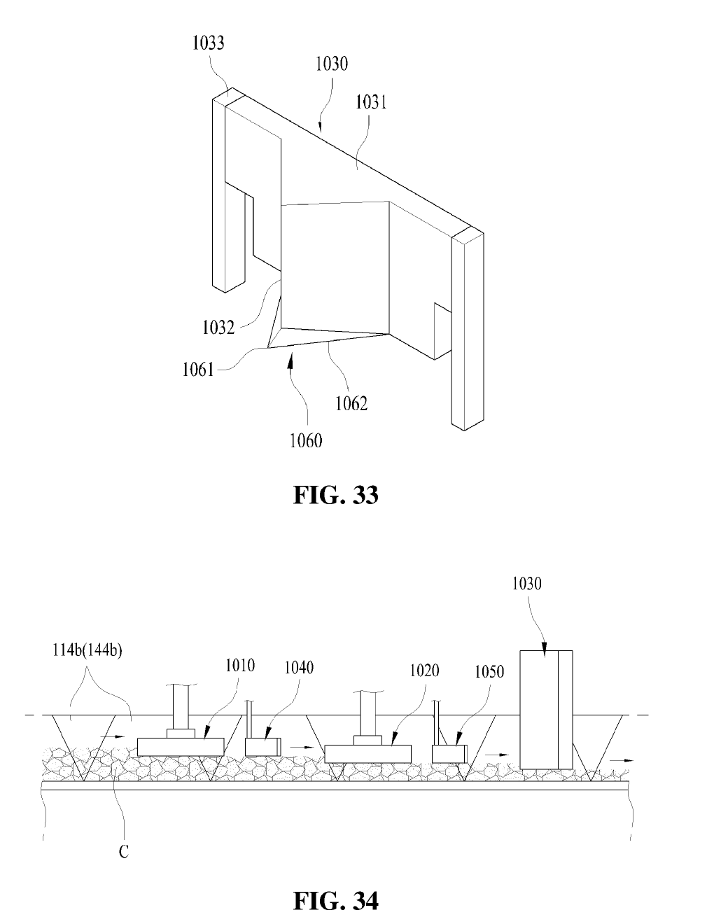

Further, in FIG. 32, each of the first dispersion flattener 1010 and the second dispersion flattener 1020 further has a dispersion boss 1060 that has an edge 1061 which protrudes from a front side of a lower edge of a division boss and a blade 1062 which protrudes from opposite side surfaces of the lower edge of the division boss, and that has inclined surfaces having a specific slope, which become wider as they go from the edge 1061 to the blade 1062 from above to below. Further, in FIG. 33, the flattener further has a dispersion boss 1060 that has an edge 1061 which protrudes from a front side of a lower edge of a division boss and a blade 1062 which protrudes from opposite side surfaces of the lower edge of the division boss and that has inclined surfaces having a specific slope, which become wider as they go from the edge 1061 to the blade 1062 from above to below.

The dispersion boss 1060 has the edge 1061 that protrudes from the front side of the lower edge of the division boss 1012 and the blade 1062 that protrudes from the edge 1061 to opposite side surfaces of the lower edge of the division boss 1012. Inclined surfaces having a specific slope, which become wider as they go from the edge 1061 to the blade 1062 of the dispersion boss 1060, are formed. The dispersion boss 1060 crosses a central portion of the piles of the coals that are transferred by the transportation device, by the edge 1061, to divide the central portion having a high density. The dispersion boss 1060 allows coals, which flow down after the piles of the coals divided by the edge 1011 and the division boss 1012 are dispersed into opposite sides along the division boss 1012, to flow down to front sides of the inclined surfaces on opposite sides so as to disperse the piles of the coals at a uniform density and uniformly spread the piles of the coals on a surface of the transportation device.

Meanwhile, in FIG. 34, the first dispersion flattener 1010, the second dispersion flattener 1020 and the flattener 1030 are installed to have specific height steps from the surfaces of the first transfer plates 114 at a specific interval to become lower as they go from front to rear. That is, they are installed such that a bottom surface of the first dispersion flattener 1010 is lower than a bottom surface of the second dispersion flattener 1020 and a bottom surface of the flattener 1030 is lower than the second dispersion flattener 1020. Thus, the first dispersion flattener 1010 and the second dispersion flattener 1020 uniformly disperse loads of the piles of the coals C that are transferred on surfaces of the first transfer plates 114, which face an upper side while neither being biased to any one side nor having irregular heights and flatten the loads to gradually become lower at a specific height interval as well. Further, the flattener 1030 more lower and uniformly flattens the piles of the coals C that has passed through the second dispersion flattener 1020 to allow reheat steam sprayed while passing through the first transfer plates 114 to uniformly come into contact with surfaces of coal particles.

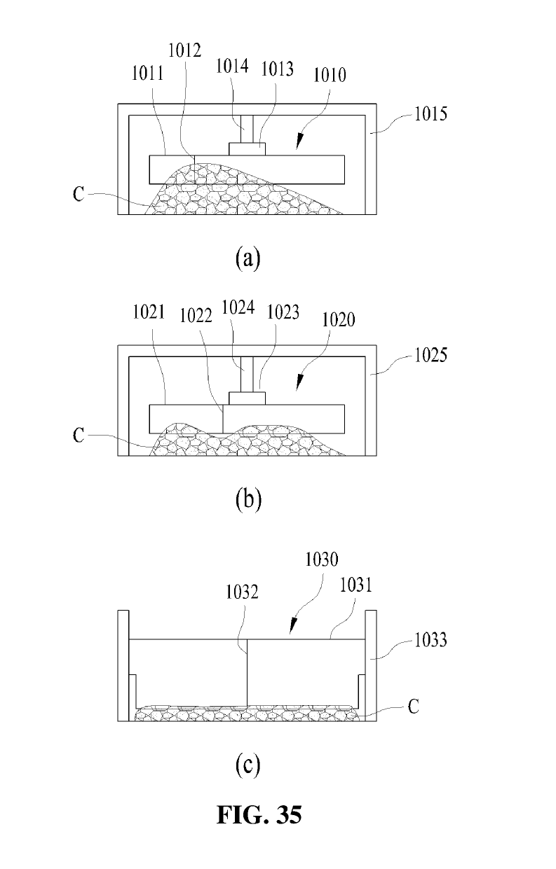

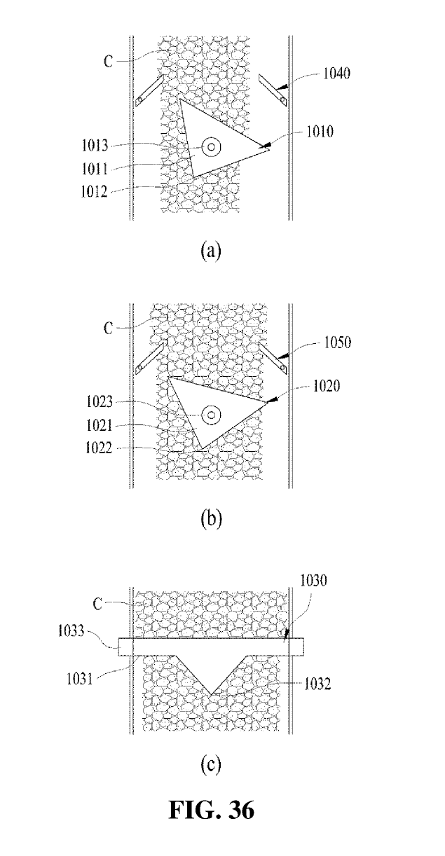

In addition, in FIGS. 35A and 36A, the piles of the coals C that are input from the dust reducer 1 to the surfaces of the first transfer plates 114 and are transferred have an approximately circular arc shape but may be formed to be biased to any one side or have irregular heights. Here, when the piles of the coals C are biased to any one side, the first dispersion flattener 1010 is rotated by loads of the piles of the biased coals C while dividing and dispersing the piles of the coals C by the division boss 1012. The body 1011 that is elastically supported at the fixing shaft 1014 by the restoration member 1013 is rotated to a side where the loads of the piles of the coals C are large. While the body 1011 is rotated and supported by elasticity of the restoration member 1013, the piles of the coals C are transferred while passing through the body 1011 of the first dispersion flattener 1010. Thus, the division boss 1012 faces a side where the loads of the piles of the coals C are large so as to effectively divide and disperse a center of the piles of the biased and transferred coals C. In addition, because positions to which the transferred piles of the coals C are biased may be different, the piles of the coals C are dispersed and flattened by the division boss 1012 toward the side where the loads are large by elasticity of the restoration member 1013, when the loads are changed. Further, because the piles of the coals C that has passed through the first dispersion flattener 1010 may be irregularly dispersed on the surfaces of the first transfer plates 114, the pair of first transportation coal guide plates 1040 collect the piles of the coals C to inner sides of the first transfer plates 114. Thus, the piles of the coals C that have a biased load are dispersed by the first dispersion flattener 1010 and are then collected at a specific load and a specific height by the first transportation coal guide plates 1040.

Further, in FIGS. 35B and 36B, the second dispersion flattener 1020 secondarily disperses and flattens the loads of the piles of the coals C that have passed through the first transportation coal guide plates 1040. Here, the second dispersion flattener 1020 disperses and flattens the piles of the coals C at a position of a bottom surface that is further lower than the first dispersion flattener 1010. The transferred piles of the coals C having biased loads are divided and dispersed by also the second dispersion flattener 1020 and are then collected to the inner sides of the first transfer plates 114 through the second transportation coal guide plates 1050. The second transportation coal guide plates 1050 has a length smaller than that of the first transportation coal guide plates 1040 or has an inclination angle gentler than that of the first transportation coal guide plates 1040, which corresponds to the transferred piles of the coals C, so as to more widely disperse the piles of the coals C on the surfaces of the first transfer plates 114.

Further, in FIGS. 35C and 36C, the flattener 1030 further disperses and flattens the piles of the coals C that have passed through the second transportation coal guide plates 1050. Here, the flattener 1030 disperses and flattens the piles of the coals C at a position of a bottom surface that is further lower than the second dispersion flattener 1020. Thus, the piles of the coals C that have passed through the flattener 1030 are transferred while being uniformly dispersed and distributed on the surfaces of the first transfer plates 114 with few change in the density thereof at approximately the same thickness. Therefore, the piles of the coals C that are input from the dust reducer 1010 and have a specific volume, a specific weight and irregular and biased loads are dispersed and flattened while passing through the first dispersion flattener 1010, the second dispersion flattener 1020 and the flattener 1030 and the reheat steam sprayed while passing through the first transfer plates 114 uniformly comes into contact with surfaces of coal particles, thereby more effectively drying the coals.

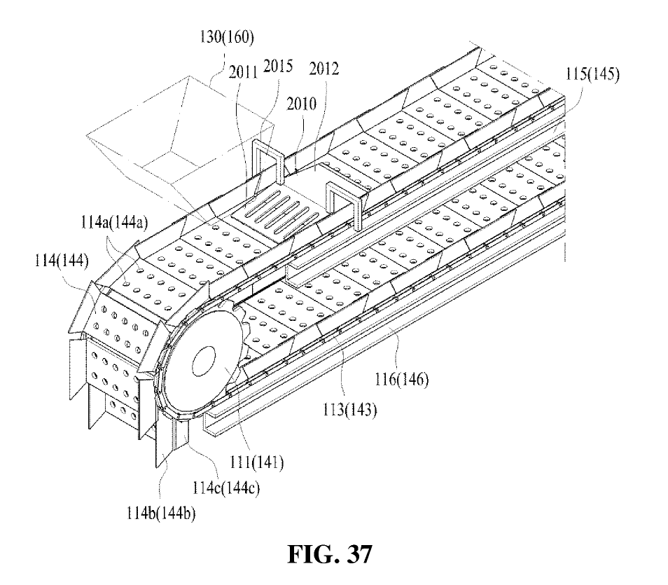

Next, a fifth embodiment of the dispersing flattening apparatus for uniform drying of transportation coals in a coal dryer using reheat steam according to the present invention will be described in detail with reference to FIGS. 37 to 41.

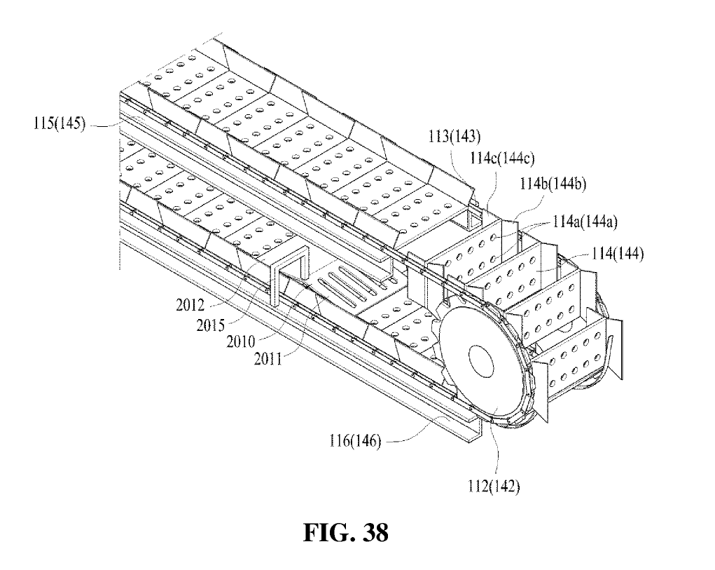

In FIGS. 37 and 38, sorters 2010 may be installed at front ends of the first flue gas chamber 124 and the second flue gas chamber 126 to disperse and flatten the piles of the coals C that fall from the first upper transfer plates 114 onto the surfaces of the first lower transfer plates 114. Further, the sorters 2010 may be installed at front ends of the third flue gas chamber 154 and the fourth flue gas chamber 156 to disperse and flatten the transferred piles of the coals C. In addition, one or more sorters 2010 may be also installed inside the first flue gas chamber 124, the second flue gas chamber 126, the third flue gas chamber 154 and the fourth flue gas chamber 156. Thus, the sorters 2010 are installed in the first flue gas chamber 124, the second flue gas chamber 126, the third flue gas chamber 154 and the fourth flue gas chamber 156 to disperse and equalize loads and a density of the input and fallen piles of the coals so as to allow the reheat steam sprayed while passing through the first transfer plates 114 and the second transfer plates 144 to be uniformly in contact with surfaces of coal particles, thereby more effectively drying the coals.

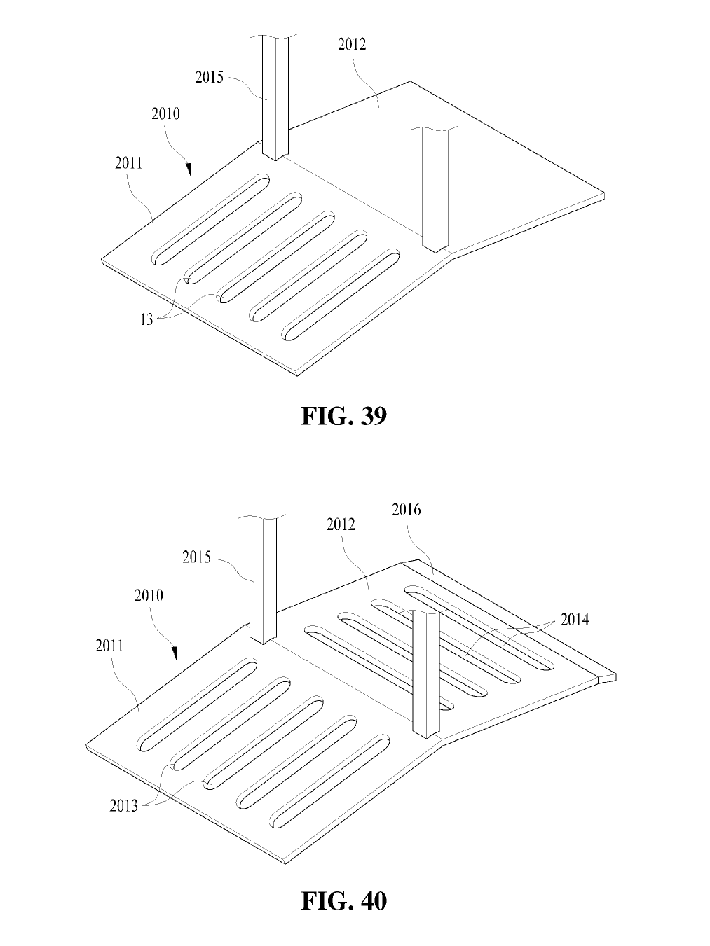

In FIG. 39, each sorter 2010 is obtained by integrally coupling a rising plate 2011 that has a slope that rises at a specific angle as it goes from front to rear and a lowering plate 2012 that is bonded to an end of the rising plate and has a slope that is lowered at a specific angle as it rearward goes. A plurality of first through-holes 2013 are horizontally formed in the rising plate 2011 at a specific internal to have a specific length. Further, the sorter 1 in which the rising plate 2011 and the lowering plate 2012 are integrally coupled to each other are fixedly supported by a pair of fixing members 2015 on opposite sides thereof, respectively. One fixing member 2015 is coupled to a side surface on which the rising plate 2011 and the lowering plate 2012 are bonded to each other and the other fixing member 2015 is fixed to a first guide rail 115.

In addition, the sorter 2010 performs sorting that horizontally disperses the density of piles of coals that are transferred on the surfaces of the first transfer plates 114, which face an upper side, and uniformly equalizes the density. One or more sorters 2010 may be installed at a specific interval.

In FIG. 40, a plurality of second through-holes 2014 are horizontally formed on the lowering plate 2012 of the sorter 2010 at a specific interval to have a specific width. The second through-holes 2014 may be vertically formed on the lowering plate 2012. Further, the first through-holes 2013 formed on the rising plate 2011 may be horizontally formed. Thus, all the through-holes formed on the rising plate 2011 and the lowering plate 2012 may be formed vertically or horizontally or may be formed selectively in a vertical direction or in a horizontal direction.

Further, a flattening member 2016 having elasticity is coupled to a longitudinal cross-section of the lowering plate 2012 of the sorter 2010. The flattening member 2016 may be formed of a material having elasticity such as synthetic resin and rubber to flatten irregularly transferred coals.

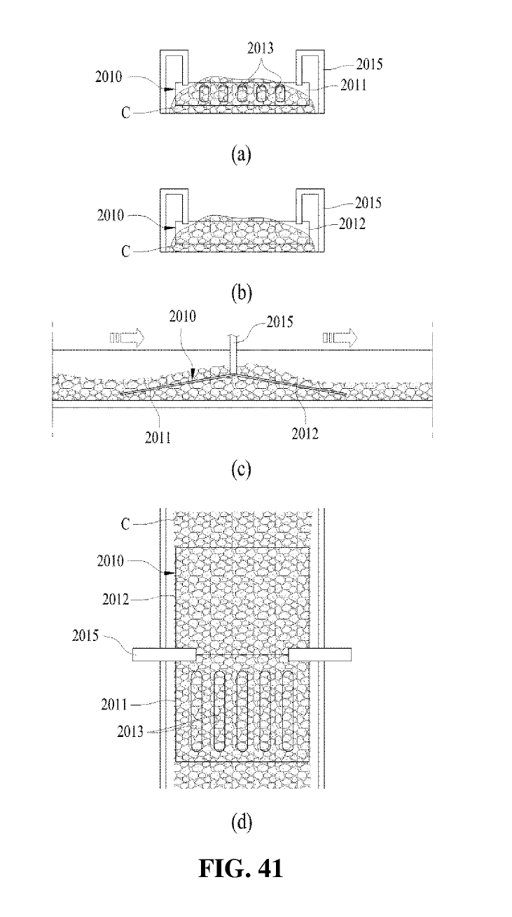

In FIGS. 41A to 41C, the piles of the coals C that are input from the dust reducer 1 to the surfaces of the first transfer plates 114 and are transferred have an approximately circular arc shape but may be formed to be biased to any one side or have irregular heights. Further, a density of the transferred piles of the coals C becomes high at a central portion and a lower portion thereof by gravity. To this end, in the piles of the coals C, the reheat steam sprayed from bottom surfaces of the first transfer plates 114 is not uniformly input into coal particles so that efficiency in drying coals may be reduced. Here, the piles of the coals C transferred by the first transfer plates 114 are horizontally separated while passing through a lower portion of the rising plate 2011 of the sorter 2010. The separated piles of the coals C are raised along a surface of the rising plate 2011. The piles of the coals C that are raised to the surface of the rising plate 2011 are introduced to a lower side of the rising plate 2011 through the first through-holes 2013 or climb over the rising plate 20111 to be transferred to a surface of the lowering plate 12. The piles of the coals C that are lowered to the surface of the lowering plate 12 are introduced to a lower side of the lowering plate 2012 through the second through-holes 2014 or are input onto piles of coals C that pass by the surface of the lowering plate 2012 and pass through a bottom surface of the lowering plate 2012.

When a bottom surface of the rising plate 2011 or a bottom surface of the lowering plate 2012 of the sorter 2010 is installed almost adjacent to the surfaces of the first transfer plates 114, the piles of the coals C that transferred by the first transfer plates 114 are not united by passing through the sorter 2010 and are thus transferred in a state in which loads or a density of the piles of the coals C are dispersed and equalized. Thus, the sorter 2010 uniformly mixes the transferred piles of the coals C, thereby maximizing drying efficiency.

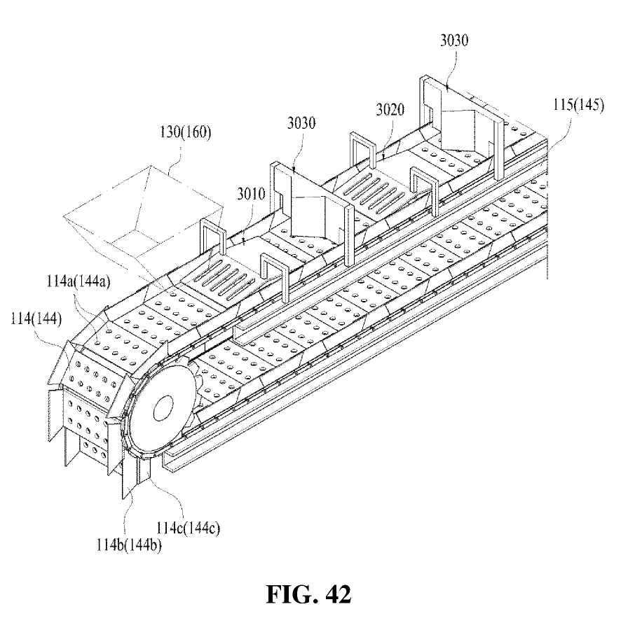

Next, a sixth embodiment of the dispersing flattening apparatus for uniform drying of transportation coals in a coal dryer using reheat steam according to the present invention will be described in detail with reference to FIGS. 42 to 46.

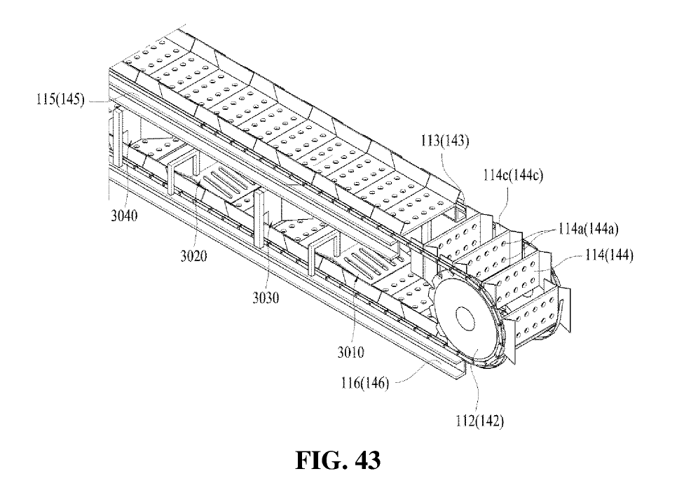

In FIGS. 42 and 43, a first sorter 3010, a first flattener 3020, a second sorter 3020 and a second flattener 3040 are installed at front ends of the first flue gas chamber 124 and the second flue gas chamber 126 to disperse and flatten piles of coals C that fall from the first upper transfer plates 114 to the surfaces of the first lower transfer plates 114. Further, the sorter 3010, the first flattener 3030, the second sorter 3020 and the second flattener 3040 are installed at front ends of the third flue gas chamber 154 and the fourth flue gas chamber 156 to disperse and flatten the transferred piles of the coals C. In addition, the sorter 3010, the first flattener 3030, the second sorter 3020 and the second flattener 3040 may be also installed inside the first flue gas chamber 124, the second flue gas chamber 126, the third flue gas chamber 154 and the fourth flue gas chamber 156. Thus, the first sorter 3010, the first flattener 3030, the second sorter 3020 and the second flattener 3040 are installed in the first flue gas chamber 124, the second flue gas chamber 126, the third flue gas chamber 154 and the fourth flue gas chamber 156 to disperse and flatten loads of the input and fallen piles of the coals so as to allow reheat steam sprayed while passing through the first transfer plates 114 and the second transfer plates 144 to be uniformly in contact with surfaces of coal particles, thereby more effectively drying the coals.

The sorter 3010 has the same structure as that of FIGS. 39 and 40 of the fifth embodiment. In addition, the flatteners 3030 and 3040 have the same configuration and structure as those of FIGS. 31 and 33 of the fourth embodiment and achieve the same effect.

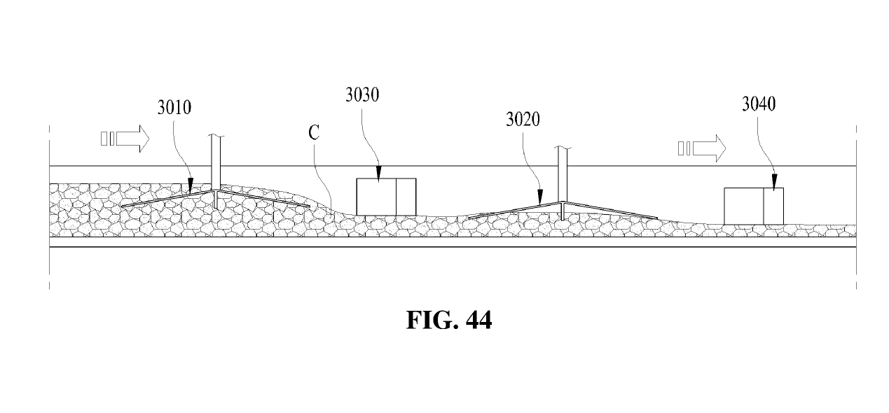

Thus, in FIG. 44, the first sorter 3010, the first flattener 3030, the second sorter 3020 and the second flattener 3040 are installed to have specific height steps from the surfaces of the first transfer plates 114 at a specific interval to become lower as they go from front to rear. That is, they are installed such that a bottom surface of the first flattener 3030 is lower than a bottom surface of the first sorter 3010, a bottom surface of the second sorter 3020 is lower than the first flattener 3030 and a bottom surface of the second flattener 3040 is lower than the second sorter 3020.

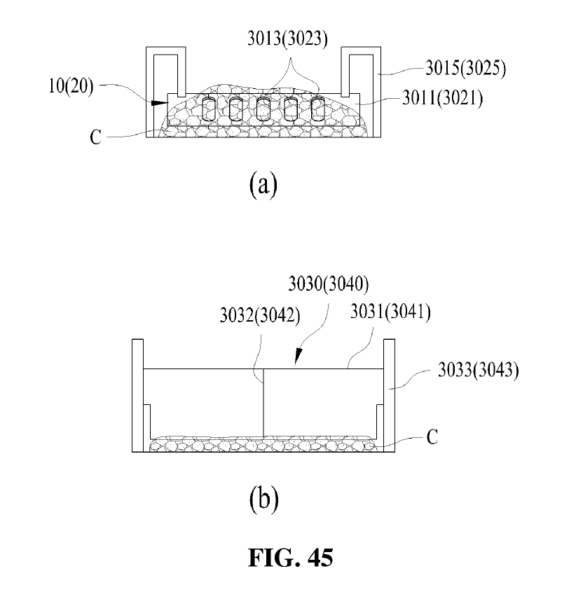

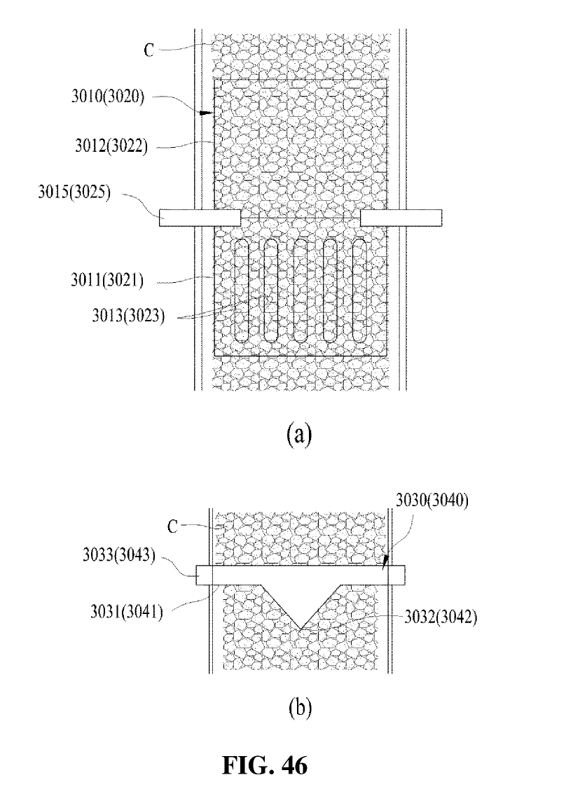

In FIGS. 45A, 45B, 46A and 46B, the piles of the coals C that are input from the dust reducer 1 to the surfaces of the first transfer plates 114 and are transferred have an approximately circular arc shape but may be formed to be biased to any one side or have irregular heights. Further, a density of the transferred piles of the coals C becomes high at a central portion and a lower portion thereof by gravity. To this end, in the piles of the coals C, the reheat steam sprayed from bottom surfaces the first transfer plates 114 is not uniformly input into coal particles so that efficiency in drying coals may be reduced. Here, the piles of the coals C transferred by the first transfer plates 114 are horizontally separated while passing through a lower portion of the rising plate 3011 of the sorter 3010. The separated piles of the coals C are raised along the surface of the rising plate 3011. The piles of the coals C that are raised to the surface of the rising plate 3011 are introduced to a lower side of the rising plate 3011 through the first through-holes 3013 or climb over the rising plate 20111 to be transferred to the surface of the lowering plate 3012. Further, the piles of the coals C that are lowered to the surface of the lowering plate 3012 are introduced to a lower side of the lowering plate 3012 through the second through-holes 3014 or are input onto piles of coals C that pass by the surface of the lowering plate 3012 and pass through a bottom surface of the lowering plate 3012. Further, a brush 3017 vertically installed on the bottom surface of the first sorter 3010 uniformly disperses surfaces of the piles of the coals C that pass by the rising plate 3011 or pass through the first through-holes 3013, to form a peak and a valley. The piles of the coals C that transferred by the first transfer plates 114 are not united by passing through the first sorter 3010 and are thus transferred in a state in which loads or a density of the piles of the coals C are dispersed and equalized. Thus, the first sorter 3010 uniformly mixes the transferred piles of the coals C, thereby maximizing drying efficiency.

Further, the first flattener 3030 further disperses and flattens the piles of the coals C that have passed through the first sorter 3010. Here, the flattener 3030 disperses and flattens the piles of the coals C at a position of a bottom surface that is further lower than the first sorter 3010. Thus, the piles of the coals C that have passed through the first flattener 3030 are transferred while being uniformly dispersed and distributed on the surfaces of the first transfer plates 114 with few change in the density thereof at approximately the same thickness.

The piles of the coals C that have passed through the first flattener 3030 are horizontally separated while passing through a lower portion of a rising plate 3021 of the second sorter 3020. The separated piles of the coals C are raised along the surface of the rising plate 3021. The piles of the coals C that are raised to the surface of the rising plate 3021 are introduced to a lower side of the rising plate 3021 through first through-holes 3023 or climb over the rising plate 3021 to be transferred to the surface of the lowering plate 3022. Further, the piles of the coals C that are lowered to the surface of the lowering plate 3022 are introduced to a lower side of the lowering plate 3022 through the second through-holes 3024 or are input onto piles of coals C that pass by the surface of the lowering plate 3022 and pass through a bottom surface of the lowering plate 3022. Further, a brush 3027 vertically installed on the bottom surface of the second sorter 3020 uniformly disperses surfaces of the piles of the coals C that pass by the rising plate 3021 or pass through the first through-holes 3023, to form a peak and a valley. The piles of the coals C that transferred by the first transfer plates 114 are not united by passing through the second sorter 3020 and are thus transferred in a state in which loads or a density of the piles of the coals C are dispersed and equalized. Thus, the second sorter 3020 uniformly mixes the transferred piles of the coals C, thereby maximizing drying efficiency.

Further, the second flattener 3040 further disperses and flattens the piles of the coals C that have passed through the second sorter 3020. Here, the second flattener 3040 disperses and flattens the piles of the coals C at a position of a bottom surface that is further lower than the second sorter 3020. Thus, the piles of the coals C that have passed through the first flattener 3040 are transferred while being uniformly dispersed and distributed on the surfaces of the first transfer plates 114 with few change in the density thereof approximately at the same thickness.

The piles of the coals C transferred on the surfaces of the first transfer plates 114 are repeatedly mixed up, dispersed and flattened while passing through the first sorter 3010, the first flattener 3030, the second sorter 3020 and the second flattener 3040 so that loads of the piles of the coals C that are transferred while neither being biased to any one side nor having irregular heights are uniformly dispersed so as not to be biased to any one side and are flattened to become gradually lower at a specific height interval. Thus, the reheat steam sprayed while passing through the first transfer plates 114 uniformly comes into contact with surfaces of coal particles, thereby more effectively drying the coals.

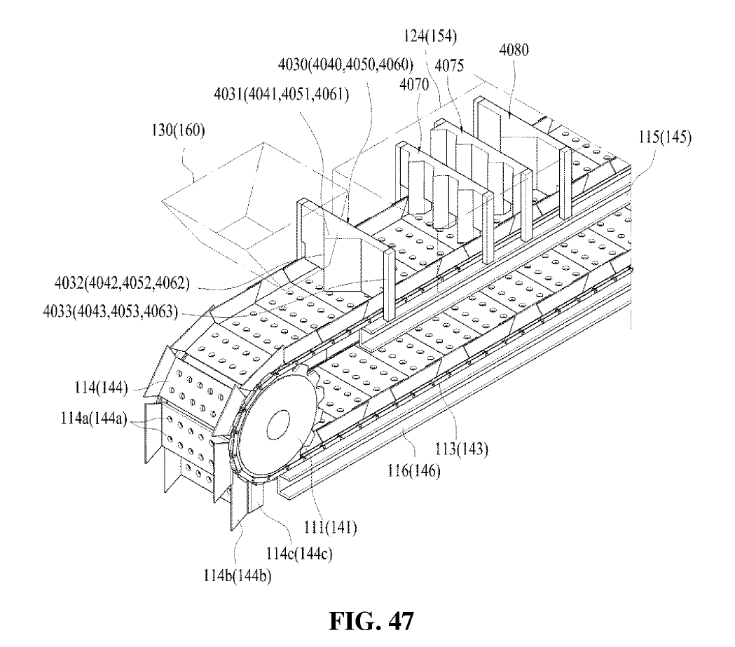

Next, a seventh embodiment of the dispersing flattening apparatus for uniform drying of transportation coals in a coal dryer using reheat steam according to the present invention will be described in detail with reference to FIGS. 47 to 51.

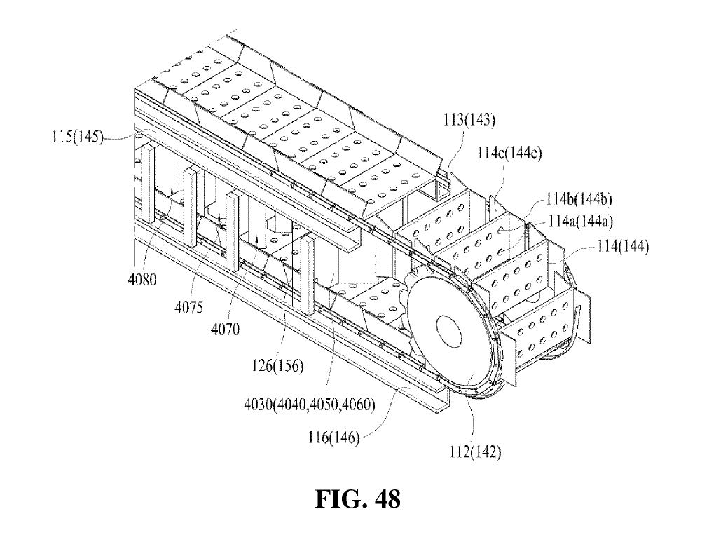

47 In FIG. 48, a first flattener 4030 includes a column-shaped body 4031, a dispersion boss 4032 that protrudes from a center of a front surface of the body, and a pair of fixing members 4033 that fixedly support opposite ends of the body 4031. That is, the flattener 4030 includes the column-shaped body 4031. A surface of the body 4031, through which coals may be uniformly dispersed on the transportation device, may be formed to have a polygonal shape or an elliptical shape. Further, the division boss 4032 that divides and disperses a center of transferred piles of coals into left and right parts protrudes from a center of a front surface of the body 4031. The division boss 4032 has an approximately triangular column shape and has an edge having an intersection line in front of the body 4031. Thus, when the piles of the coals come into contact with the division boss 4032, coal particles are divided into opposite left and right sides by the division boss 4032. Thus, the division boss 4032 performs a function of dividing and dispersing the center of the piles of the coals into left and right parts and flattening the piles of the coals as well. Opposite ends of the body 4031 having the division boss 4032 that protrudes therefrom are fixedly supported by the pair of fixing members 4033 that are fixed to one side of the transportation device. Further, the first flattener 4030 flattens the piles of the coals, which are transferred by the transportation device, at a specific height, and thus, allows the reheat steam sprayed while passing through the transportation device to uniformly come into contact with surfaces of coal particles.

In addition, second to fourth flatteners 4040, 4050 and 4060 also have the same configuration and structure as those of the first flattener 4030.

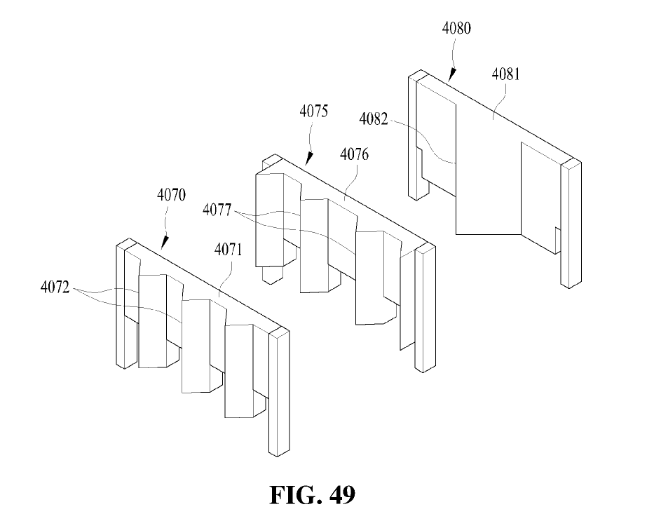

Meanwhile, in FIG. 49, a first divider 4070, a second divider 4075 and a dispersion flattener 4080 that divide and collect the piles of the coals that are dried while being transferred after being dispersed and flattened and disperse and flatten the piles of the coals again are installed inside a plurality of first flue gas chambers 124 installed on the first upper transfer plates 114 that are installed in the first coal dryer 110.

The first divider 4070 has a plurality of first division bosses 4072 horizontally spaced apart from each other at a specific interval to protrude from a lower portion of an approximately rectangular body 4071. It is preferred that each first division boss 4072 has a triangular edge formed on a front side thereof to easily divide the piles of the coals. Further, passages through which the coals divided by the first division bosses 4072 pass are formed between the first division bosses 4072. Further, it is preferred that the first division bosses 4072 are installed to be in contact with the surface of the first upper transfer plates 114 or to have fine spacing therebetween. This enables lower ends of the first division bosses 4072 to separate coals stuck to the surface of the first upper transfer plates 114 that transfers the piles of the coals so that the surface of the first upper transfer plates 114 may always be maintained clean and flat. It is preferred that the first divider 4070 may be fixed to a side surface of the first flue gas chamber 124 by a fixing member.

Further, the second divider 4075 is installed on a rear side of the first divider 4070 to be spaced apart therefrom at a specific interval. The second divider 4075 has a plurality of second division bosses 4077 horizontally spaced apart from each other at a specific interval to protrude from a lower portion of an approximately rectangular body 4076. It is preferred that each second division boss 4077 has a triangular edge formed on a front side thereof to easily divide the piles of the coals. Further, passages through which the coals divided by the second division bosses 4077 pass are formed between the first division bosses 4077. It is preferred that the second division bosses 4077 that protrude from the body 4076 are located between the first division bosses 4072 of the first divider 4070, that is, at a location where the passages are formed. This may enable the second division bosses 4077 to divide the piles of the coals that are transferred while being collected in the passages of the first division bosses 4072, the first division bosses 4072. Thus, the piles of the coals that are divided by the first division bosses 4072 of the first divider 4070 and are transferred through the passages between the first division bosses 4072 may be divided by the second division bosses 4077 of the second divider 4075, so that the piles of the coals that are transferred on the surfaces of the first upper transfer plates 114 are repeatedly divided and collected while passing through the first divider 4070 and the second divider 4075. Thus, the piles of the coals are roasted and mixed up so that drying effects of the piles of the coals may be improved. Further, it is preferred that the second division bosses 4077 are installed to be in contact with the surface of the first upper transfer plates 114 or to have fine spacing therebetween. This enables lower ends of the second division bosses 4077 to separate coals stuck to the surfaces of the first upper transfer plates 114 that transfers the piles of the coals so that the surfaces of the first upper transfer plates 114 may always be maintained clean and flat. It is preferred that the second divider 4075 may be fixed to the side surface of the first flue gas chamber 124 by a fixing member.

Further, the diversion flattener 4080 is installed on a rear side of the second divider 4075 with a specific interval. The dispersion flattener 4080 disperses and flattens the piles of the coals that are divided and collected by the second division bosses 4077 of the second divider 4075. The dispersion flattener 4080 has a division boss 4082 that protrudes from a center of a front surface of a column-shaped body 4081. The piles of the coals that have passed through the dispersion flattener 4080 are consistently dried by the reheat steam sprayed from lower sides of the first upper transfer plates 114. It is preferred that the dispersion flattener 4080 may be fixed to the side surface of the first flue gas chamber 124 by a fixing member.

Thus, the first divider 4070, the second divider 4075 and the dispersion flattener 4080 are installed as one structure inside each first flue gas chamber 124. Further, the first divider 4070, the second divider 4075 and the dispersion flattener 4080 may be plural. In addition, it is preferred that the first divider 4070, the second divider 4075 and the dispersion flattener 4080 are installed at an inner center or on a rear side of the first flue gas chamber 124.

Further, the first divider 4070, the second divider 4075 and the dispersion flattener 4080 are installed within a plurality of second flue gas chambers 126 that are installed on the first lower transfer plates 114.

Further, the first divider 4070, the second divider 4070 and the dispersion flattener 4080 are installed inside a plurality of third flue gas chambers 154 installed on the second upper transfer plates 144 installed in the second coal dryer 140 and a plurality of fourth flue gas chambers 156 installed on the second lower transfer plates 144,

Therefore, the piles of the coals that are transferred while being stacked on the surfaces of the first upper and lower transfer plates 114 and the second upper and lower transfer plates 144 are divided, collected, dispersed and flattened by the first divider 4070, the second divider 4075 and the dispersion flattener 4080 that are installed in each flue gas chamber while being dried by the reheat steam by passing through the first flue gas chamber 124, the second flue gas chamber 126, and the third flue gas chamber 154 and the fourth flue gas chamber 156, so that drying efficiency is improved.

The second flattener 4040 horizontally divides, disperses and flattens a center of the piles of the coals C that fall onto and are transferred on the surfaces of the first lower transfer plates, which face an upper side. This is to transfer the piles of the coals that are transferred by and fall from the first upper transfer plates 114 after the piles of the coals are uniformly dispersed and flattened on the surfaces of the first lower transfer plates 114 because the piles of the coals are irregularly stacked.

Further, the third flattener 4050 horizontally divides, disperses and flattens a center of the piles of the coals C that fall onto and are transferred on the surfaces of the second upper transfer plates 144 in the first coal dryer, which face an upper side. This is to transfer the piles of the coals that are input from the first coal dryer after the piles of the coals are uniformly dispersed and flattened on the surfaces of the second upper transfer plates 144 because the piles of the coals are irregularly stacked.

Further, the fourth flattener 4060 horizontally divides, disperses and flattens a center of the piles of the coals C that fall and are input onto and are transferred on the surfaces of the second upper transfer plates 144 in the first coal dryer, which face an upper side. This is to transfer the piles of the coals that are transferred by and fall from the second upper transfer plates 144 after the piles of the coals are uniformly dispersed and flattened on the surface of the second lower transfer plates 144 because the piles of the coals are irregularly stacked.

Thus, when coals that are input by the fixed quantity coal supplier 400 at a fixed quantity are input onto and transferred on the surfaces of the first upper transfer plates 114 of the first coal dryer 110, the first flattener 4030 uniformly disperses and flattens piles of the transferred coals.

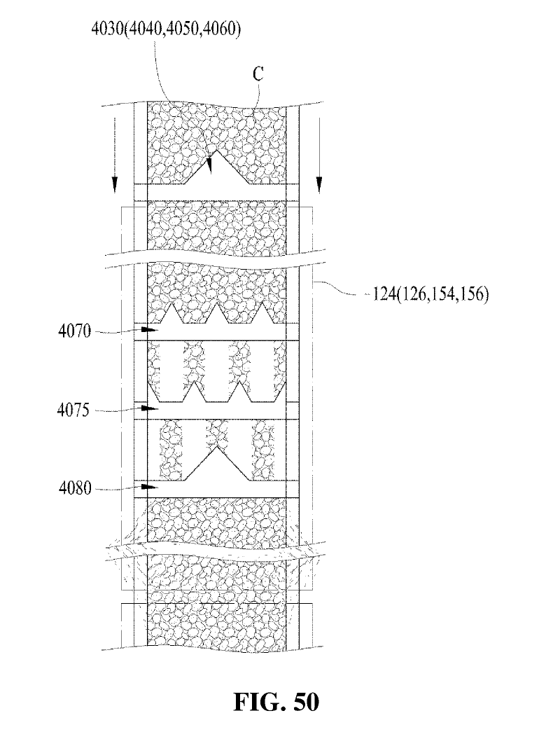

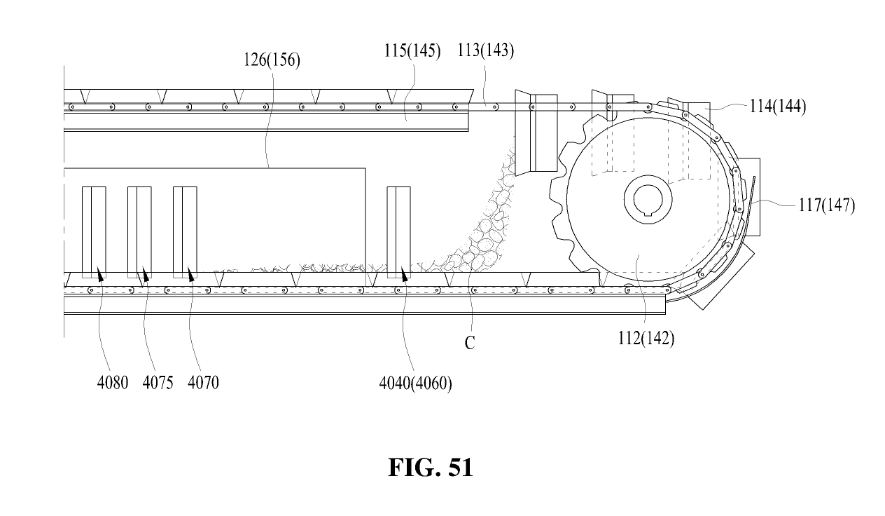

In FIGS. 50 and 51, when being transferred to the first flue gas chamber 124 while being dispersed and flattened, the piles of the coals C that are stacked on the surfaces of the first upper transfer plates 114 and pass through the first flattener 4030 are dried by reheat steam sprayed by the first steam chamber 120. Here, the piles of the coals C are separated and divided to between the first division bosses 4072 by the first division bosses 4072 by passing through the first divider 4070 installed inside the first flue gas chamber 124, the divided and collected piles of the coals C are separated and divided by the second division bosses 4077 of the second divider 4075 again, and the divided and collected piles of the coals C are dispersed and flattened by passing through the dispersion flattener 4080. Accordingly, the piles of the coals C are divided, collected and mixed up by the first divider 4070, the second divider 4075 and the dispersion flattener 4080 while being stacked on the surfaces of the first upper transfer plates 114, and thus, the reheat steam sprayed in the first steam chamber 120 uniformly comes into contact with even non-contact portions, so that the coals may be efficiently dried.

Further, the piles of the coals C that are dried by the sprayed reheat steam while being stacked and transferred on the surfaces of the first upper transfer plates 114 drop onto the surfaces of the first lower transfer plates 114. The piles of the coals C that are input onto the first lower transfer plates 114 are uniformly dispersed and flattened while passing through the second flattener 4040. When being transferred to the second flue gas chamber 126 while being dispersed and flattened, the piles of the coals C that are stacked on the surfaces of the first lower transfer plates 114 and pass through the second flattener 4040 are dried by reheat steam sprayed by the second steam chamber 123. Here, the piles of the coals C are separated and divided to between the first division bosses 4072 by the first division bosses 4072 by passing through the first divider 4070 installed inside the second flue gas chamber 126, the divided and collected piles of the coals C are separated and divided by the second division bosses 4077 of the second divider 4075 again, and the divided and collected piles of the coals C are dispersed and flattened by passing through the dispersion flattener 4080. Accordingly, the piles of the coals C are divided, collected and mixed up by the first divider 4070, the second divider 4075 and the dispersion flattener 4080 while being loaded on the surfaces of the first lower transfer plates 114, and thus, the reheat steam sprayed by the second steam chamber 123 uniformly comes into contact with even non-contact portions, so that the coals may be efficiently dried.

Further, when the piles of the coals that are completely dried by the first coal dryer 110 are input onto the surfaces of the second upper transfer plates 144 of the second coal dryer 140 and are transferred, the third flattener 4050 uniformly disperses and flattens the transferred piles of the coals.

When being transferred to the third flue gas chamber 154 while being dispersed and flattened, the piles of the coals C that are loaded on the surfaces of the second upper transfer plates 144 and pass through the third flattener 4050 are dried by reheat steam sprayed in the third steam chamber 150. Here, the piles of the coals C are separated and divided to between the first division bosses 4072 by the first division bosses 4072 by passing through the first divider 4070 installed inside the third flue gas chamber 154, the divided and collected piles of the coals C are separated and divided by the second division bosses 4077 of the second divider 4075 again, and the divided and collected piles of the coals C are dispersed and flattened by passing through the dispersion flattener 4080. Accordingly, the piles of the coals C are divided, collected and mixed up by the first divider 4070, the second divider 4075 and the dispersion flattener 4080 while being loaded on the surfaces of the second upper transfer plates 144, and thus, the reheat steam sprayed in the third steam chamber 150 uniformly comes into contact with even non-contact portions, so that the coals may be efficiently dried.

Further, the piles of the coals C that are dried by the sprayed reheat steam while being loaded and transferred on the surfaces of the second upper transfer plates 144 drop onto the surfaces of the second lower transfer plates 144. The piles of the coals C that are input onto the second lower transfer plates 144 are dispersed and flattened while passing through the fourth flattener 4060. When being transferred to the fourth flue gas chamber 156 while being dispersed and flattened, the piles of the coals C that are loaded on the surfaces of the second lower transfer plates 144 and pass through the fourth flattener 4060 are dried by reheat steam sprayed by the second steam chamber 153. Here, the piles of the coals C are separated and divided to between the first division bosses 4072 by the first division bosses 4072 by passing through the first divider 4070 installed inside the second flue gas chamber 156, the divided and collected piles of the coals C are separated and divided by the second division bosses 4077 of the second divider 4075 again, and the divided and collected piles of the coals C are dispersed and flattened by passing through the dispersion flattener 4080. Accordingly, the piles of the coals C are divided, collected and mixed up by the first divider 4070, the second divider 4075 and the dispersion flattener 4080 while being loaded on the surfaces of the second lower transfer plates 144, and thus, the reheat steam sprayed by the fourth steam chamber 153 uniformly comes into contact with even non-contact portions, so that the coals may be efficiently dried.

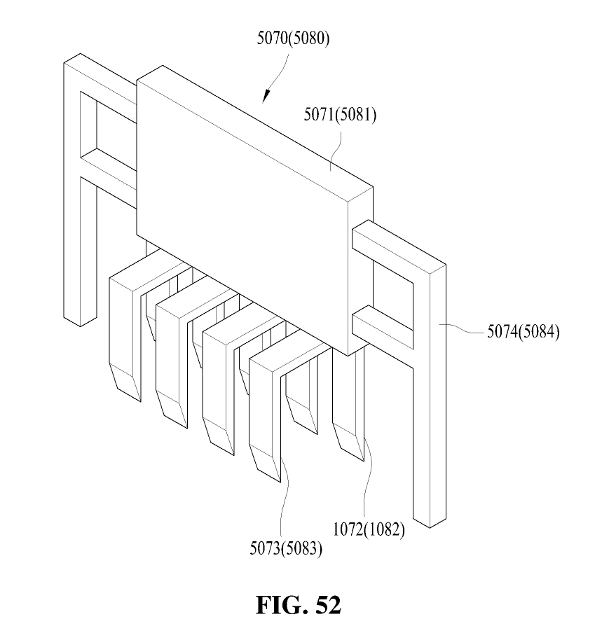

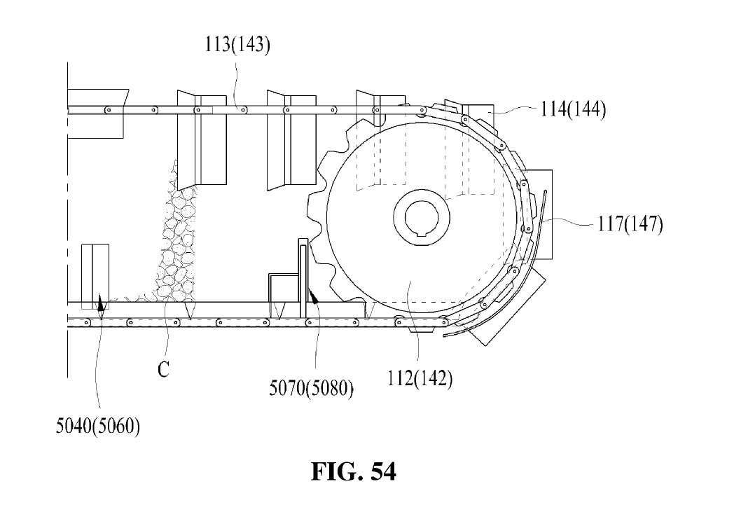

Next, a eighth embodiment of the dispersing flattening apparatus for uniform drying of transportation coals in a coal dryer using reheat steam according to the present invention will be described in detail with reference to FIGS. 52 to 54.

In FIG. 52, a first residue remover 5070 includes an approximately rectangular column-shaped body 5071. The body 5071 is fixed to opposite surfaces by fixing members 5074, respectively. A plurality of rakes 5072 protrude from a lower end of the body 5071 at a specific horizontal internal. The first rakes 5072 are in contact with the surfaces of the first lower transfer plates 114. It is preferred that the first rakes 5072 have elasticity. It is preferred that blades that are in contact with the first lower transfer plates 114 to easily rake coal residues are formed at lower ends of the first rakes 5072, respectively. Further, second rakes 5073 protrude from between the first rakes 5072. Each second rake 5073 is rearward bent at a lower end of the body at a specific angle, that is, approximately at a right angle, and a lower end thereof is in contact with the surfaces of the first lower transfer plates 114. It is preferred that the second rakes 5073 have elasticity. It is preferred that blades that are in contact with the first lower transfer plates 114 to easily rake coal residues are formed at lower ends of the second rakes 5073, respectively.

Further, the first residue remover 5070 is installed to be in contact with the surfaces of the first lower transfer plates 114 that escape from the first driven sprockets 112 through rotation. That is, this is installed between the first driven sprockets 112 and the second flattener 5040. The first residue remover 5070 may rake the entire surfaces of the first lower transfer plates 114 as the first rakes 5072 rake the surfaces of the first lower transfer plates 114 that escape from the first driven sprockets 112 at a specific horizontal interval and the second rear rakes 5073 rake the surfaces of the first lower transfer plates 114 located between the first rakes 5072. Coal residues raked by the first rakes 5072 and the second rakes 5073 are transferred while being mixed together with the piles of the coals that fall from the first upper transfer plates 114. Therefore, the first residue remover 5070 removes coal residues in the first coal dryer 110, which are stuck to the surfaces of the first upper and lower transfer plates 114 on which the piles of the coals are loaded and transferred, so that drying efficiency of coals is improved.

The second flattener 5040 horizontally divides, disperses and flattens the coal residues that are removed from the surfaces of the first lower transfer plates 114 by the first residue remover 5070 and a center of the piles of the coals C that fall from the first upper transfer plates 114 onto the surfaces of the first lower transfer plates 114, which face an upper side and are transferred. This is to transfer the coal residues from the first residue remover 5070 and the piles of the coals that are transferred by the first upper transfer plates 114 after the coal residues and the piles of the coals are uniformly dispersed and flattened on the surfaces of the first lower transfer plates 114 because the coal residues and the piles of the coals are irregularly stacked.

Further, the third flattener 5050 horizontally divides, disperses and flattens a center of the piles of the coals C that fall onto and are transferred on the surfaces of the second transfer plates 144 in the first coal dryer, which faces an upper side. This is to transfer the piles of the coals that are transferred from the first coal dryer after the piles of the coals are uniformly dispersed and flattened on the surfaces of the second upper transfer plates 144 because the piles of the coals are irregularly stacked.

A second residue remover 5080 includes an approximately rectangular column-shaped body 5081. The body 5081 is fixed to opposite surfaces by fixing members 5084, respectively. A plurality of rakes 5082 protrude from a lower end of the body 5081 at a specific horizontal internal. The first rakes 5082 are in contact with the surfaces of the second lower transfer plates 144. It is preferred that the first rakes 5082 have elasticity. It is preferred that blades that are in contact with the second lower transfer plates 144 to easily rake coal residues are formed at lower ends of the first rakes 5082, respectively. Further, second rakes 5083 protrude from between the first rakes 5082. Each second rake 5083 is rearward bent at a lower end of the body at a specific angle, that is, approximately at a right angle, and a lower end thereof is in contact with the surfaces of the second lower transfer plates 144. It is preferred that the second rakes 5083 have elasticity. It is preferred that blades that are in contact with the second lower transfer plates 144 to easily rake coal residues are formed at lower ends of the second rakes 5083, respectively. Further, the second residue remover 5080 is installed to be in contact with the surfaces of the second lower transfer plates 144 that escape from the second driven sprockets 142 through rotation. That is, this is installed between the second driven sprockets 142 and the fourth flattener 5060. The second residue remover 5080 may rake the entire surfaces of the second lower transfer plates 144 as the first rakes 5082 rake the surfaces of the second lower transfer plates 144 that escape from the second driven sprockets 142 through rotation at a specific horizontal interval and the second rear rakes 5083 rake the surfaces of the second lower transfer plates 144 located between the first rakes 5082. Coal residues raked by the first rakes 5082 and the second rakes 5083 are transferred while being mixed together with the piles of the coals that fall from the second upper transfer plates 144. Therefore, the second residue remover 5080 removes coal residues in the second coal dryer 140, which are stuck to the surfaces of the second upper and lower transfer plates 144 on which the piles of the coals are loaded and transferred, so that drying efficiency of coals is improved.

The fourth flattener 5060 horizontally divides, disperses and flattens the coal residues that are removed from the surfaces of the second lower transfer plates 144 by the second residue remover 5080 and a center of the piles of the coals C that fall from the second upper transfer plates 144 onto the surfaces of the second lower transfer plates 144, which face an upper side and are transferred. This is to transfer the coal residues from the second residue remover 5080 and the piles of the coals that are transferred by the second upper transfer plates 144 after the coal residues and the piles of the coals are uniformly dispersed and flattened on the surfaces of the second lower transfer plates 144 because the coal residues and the piles of the coals are irregularly stacked.

Thus, in the apparatus for removing coal residues stuck to transfer plates in a coal dryer according to the present invention, when coals that are input by the fixed quantity coal supplier 400 at a fixed quantity are input onto and are transferred on the surfaces of the first upper transfer plates 144 of the first coal dryer 110, the first flattener 5030 uniformly disperses and flattens piles of the transferred coals. Further, after the piles of the coals on the first upper transfer plates 114 are dried by the reheat steam while being transferred, the piles of the coals C loaded on the surfaces of the first upper transfer plates 114 drop onto the surfaces of the first lower transfer plates 114 while sides of the first upper transfer plates 114 are separated from the first guide rails 115 through rotation of the first driven sprockets 112.

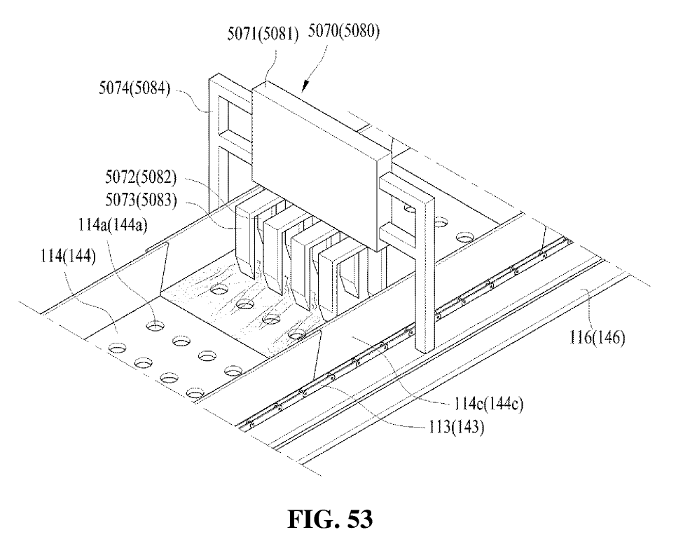

In FIG. 53, the first residue remover 5070 rakes the surfaces of the first lower transfer plates 114 by the plurality of first rakes 5072 and second rakes 5073 after the first upper transfer plates 114 are switched to the first lower transfer plates 114 through the rotation of the first driven sprockets 112. Here, coal residues stuck to the surfaces of the first lower transfer plates 114 are separated and removed. This is to prevent the coal residues from being stuck while the piles of the coals C are loaded and transferred on the surfaces of the first transfer plates 114. That is, this is because the coals are not completely dried and may thus be adhered or stuck to the surfaces of the first transfer plates 114 by moisture contained in the coals.

In FIG. 43, the coal residues removed by the first residue remover 5070 and the piles of the coals C that drop onto the surfaces of the first lower transfer plates 114 are uniformly dispersed and flattened while passing through the second flattener 5040. Further, the piles of the coals loaded on the first lower transfer plates 114 are dried by the reheat steam while being transferred.

Further, when the piles of the coals that are completely dried by the first coal dryer 110 are input from the first coal dryer 110 onto the surfaces of the second upper transfer plates 144 of the second coal dryer 140 and are transferred, the third flattener 5050 uniformly disperses and flattens the transferred piles of the coals. Further, the piles of the coals on the second upper transfer plates 144 are dried by the reheat steam while being transferred. Further, the piles of the coals C loaded on the surfaces of the first upper transfer plates 114 drop onto the surfaces of the first lower transfer plates 114 while sides of the first upper transfer plates 114 are separated from the first guide rails 115 through rotation of the first driven sprockets 112.

The second residue remover 5080 rakes the surfaces of the second lower transfer plates 144 by the plurality of first rakes 5082 and second rakes 5083 after the second upper transfer plates 144 are switched to the second lower transfer plates 144 through the rotation of the second driven sprockets 142. Here, coal residues stuck to the surfaces of the second lower transfer plates 144 are separated and removed. This is to prevent the coal residues from being stuck while the piles of the coals C are loaded and transferred on the surfaces of the second transfer plates 144. That is, this is because the coals are not completely dried and may thus be adhered or stuck to the surfaces of the second transfer plates 144 by moisture contained in the coals.

The coal residues removed by the second residue remover 5080 and the piles of the coals C that drop onto the surfaces of the second lower transfer plates 144 are uniformly dispersed and flattened while passing through the fourth flattener 5060. Further, the piles of the coals loaded on the second lower transfer plates 144 are dried by the reheat steam while being transferred.

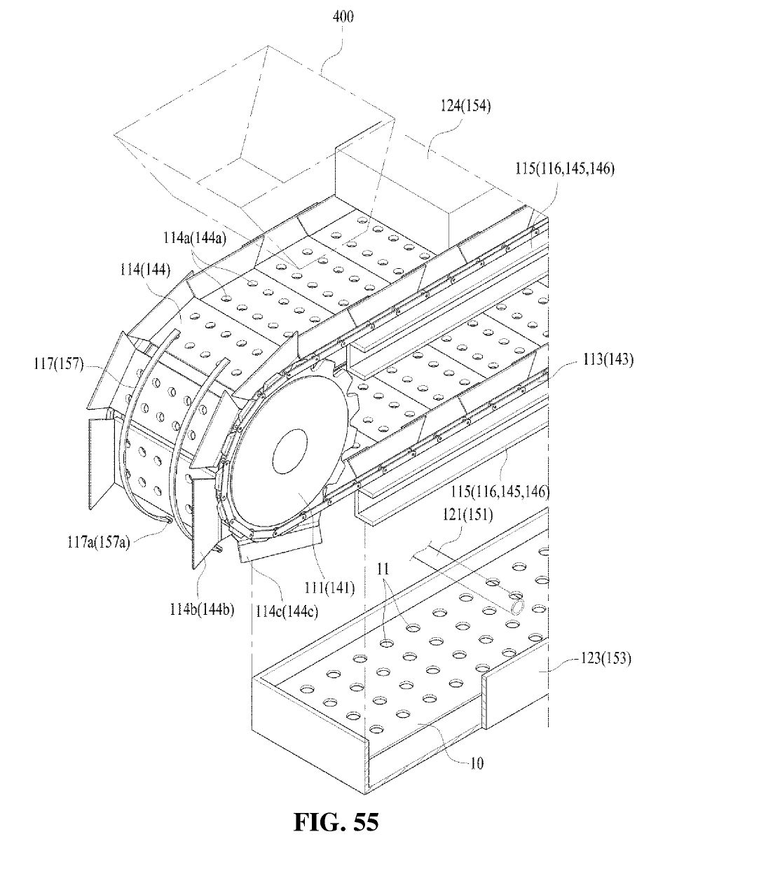

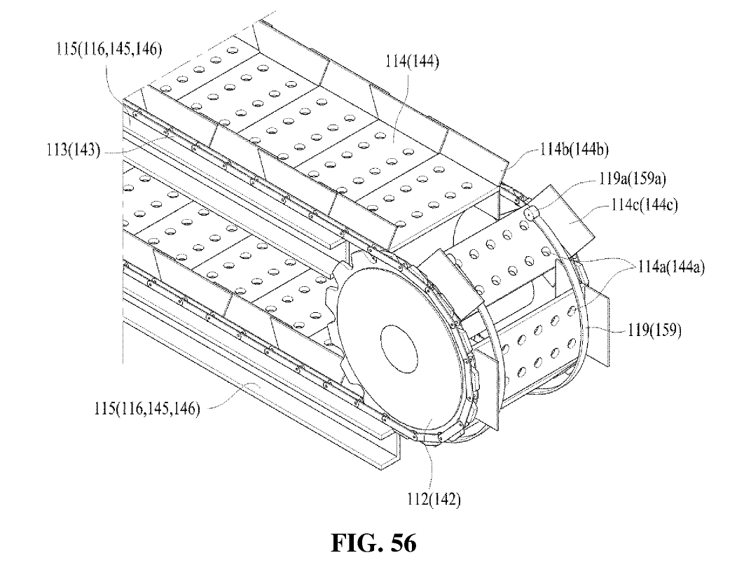

Meanwhile, a ninth embodiment of the dispersing flattening apparatus for uniform drying of transportation coals in a coal dryer using reheat steam according to the present invention will be described in detail with reference to FIGS. 55 to 59. The ninth embodiment includes a configuration and structure for dropping, feeding and supplying piles of coals, which are transferred on the transfer plates in a multi-stage dryer, onto transfer plates of a lower dryer in addition to a configuration and structure of transfer plates.

In FIGS. 31 and 32, the first flue gas chamber 124 is installed on the first guide rails 115, the second flue gas chamber 126 is installed on the second guide rail 116, the third flue gas chamber 154 is installed on the third guide rails 145 and the fourth flue gas chamber 156 is installed on the fourth guide rails 146. The first flue gas chamber 124 to the fourth flue gas chamber 156 may be partitioned and plurally installed. The first flue gas chamber 124 to the fourth flue gas chamber 156 discharge flue gas through a first gas discharge tube 125 or a second gas discharge tube 155 after the flue gas changed after being sprayed in the first steam chamber 120 to the fourth steam chamber 156 is collected.

In addition, the first steam chamber 120 is installed below the first guide rails 115 and the second steam chamber 123 is installed below the second guide rails 116. Further, the third steam chamber 150 is installed below the third guide rails 145 and the fourth steam chamber 153 is installed below the fourth guide rails 146. The first steam chamber 120 to the fourth steam chamber 153 may be partitioned and plurally installed.

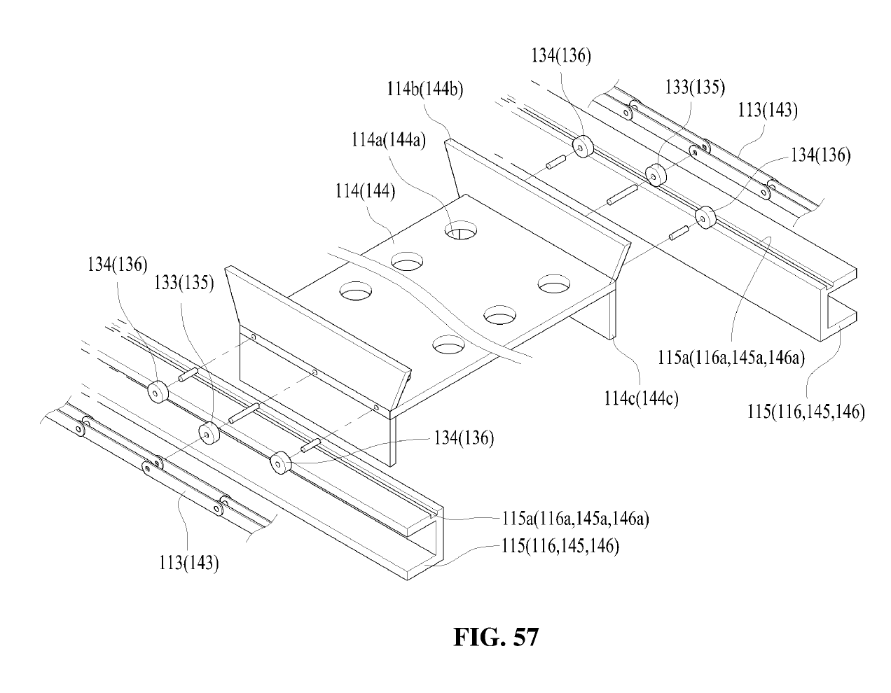

In FIG. 57, first transfer rollers 133 are hinge-coupled between centers of opposite sides of the first transfer plates 114 and the first chains 113, respectively. That is, the first transfer rollers 133 are hinge-coupled to between centers of the side surfaces of the first transfer plates 114 and the first chains 113. Further, first auxiliary rollers 134 are hinge-coupled on left and right sides of the first transfer rollers 114 on the side surfaces of the first transfer plates 114. The first auxiliary rollers 134 are hinge-coupled to side surfaces, that is, left and right sides of the first transfer plates 114.

In addition, grooves 115a and grooves 116a that guide rotation of the first transfer rollers 133 and the first auxiliary rollers 134 are formed on surfaces of the first guide rails 115 and the second guide rails 116, respectively. Thus, the first transfer plates 114 are transferred along the grooves 115a formed on the surfaces of the first guide rails 115 and the grooves 116a formed on the surfaces of the second guide rails 116 by the first transfer rollers 133 and the first auxiliary rollers 134, which are hinge-coupled thereto.

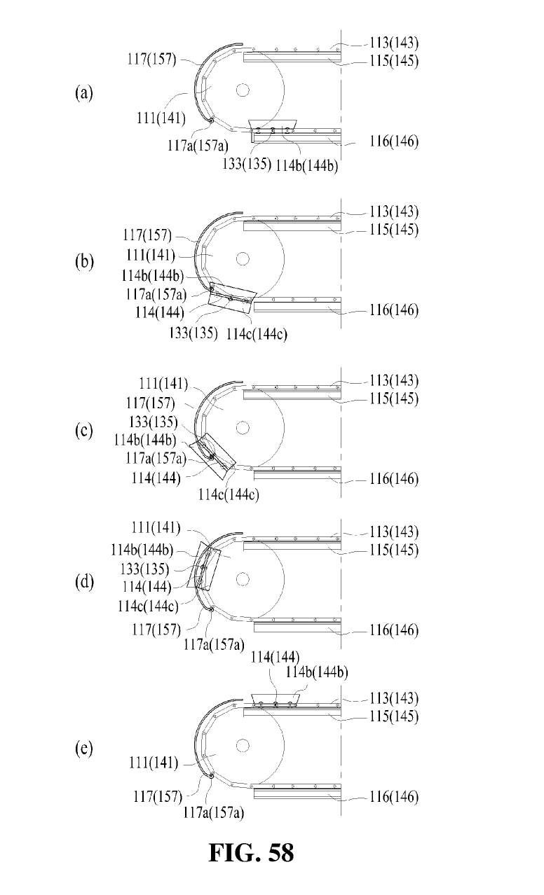

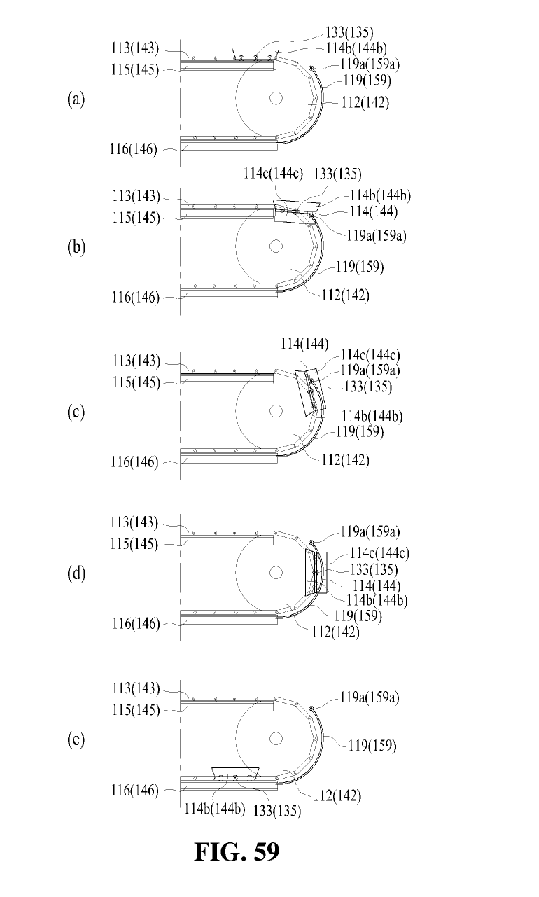

Meanwhile, in FIGS. 58 and 59, first guide bars 117 that unidirectionally rotate and upwardly support the first lower transfer plates 114 separated from the second guide rails 116 are installed from an upper side via a side surface to a lower side of the first driving sprockets 111. First triggers 117a are coupled to ends of the first guide bars 117, respectively, and the first triggers 117a are axially rotated rollers. The first triggers 117a are installed at locations that are in contact with sides of bottom surfaces of the first upper transfer plates 114.

Further, second guide bars 119 that unidirectionally rotate and downwardly support the first upper transfer plates 114 separated from the first guide rails 115 are installed from a lower side via a side surface to an upper side of the first driven sprockets 112. Second triggers 119a are coupled to ends of the second guide bars 119, respectively, and the first triggers 119a are axially rotated rollers. The second triggers 119a are installed at locations that are in contact with sides of flat surfaces of the first lower transfer plates 114.

Further, the second coal dryer 140 includes a pair of second driving sprockets 141 and a pair of second driven sprockets 142 that are fastened to each other by second chains 143 to be spaced apart from each other by a specific interval, a plurality of second transfer plates 144 that are hinge-coupled between the second chains 143, a pair of third guide rails 145 that are installed below a second upper chain 143a connected between the second driving sprockets 141 and the second driven sprockets 142 to horizontally support second upper transfer plates 144, a pair of fourth guide rails 146 that are installed below a second lower chain 143b connected between the second driving sprockets 141 and the second driven sprockets 142 to horizontally support the second transfer plates 144, a third steam chamber 150 that is installed below the second upper chain 143a to spray reheat steam supplied by the reheater 500, a fourth steam chamber 153 that is installed below the second lower chain 143b to spray the reheat steam supplied by the reheater 500, a third flue gas chamber 154 that is installed above the second upper chain 143a to collect flue gas, and a fourth flue gas chamber 156 that is installed above the second lower chain 143b to collect flue gas.

Further, in FIG. 33, the second transfer rollers 135 are hinge-coupled between centers of opposite sides of the second transfer plates 144 and the second chains 113. That is, the second transfer rollers 135 are hinge-coupled to between centers of the side surfaces of the second transfer plates 144 and the second chains 143. Further, second auxiliary rollers 136 are hinge-coupled on left and right sides of the second transfer rollers 144 on the side surfaces of the second transfer plates 114. The second auxiliary rollers 136 are hinge-coupled to side surfaces, that is, left and right sides of the second transfer plates 144.

In addition, grooves 145a and grooves 146a that guide rotation of the second transfer rollers 135 and the second auxiliary rollers 136 are formed on surfaces of the third guide rails 145 and the fourth guide rails 146, respectively. Thus, the second transfer plates 144 are transferred along the grooves 145a formed on the surfaces of the third guide rails 145 and the grooves 146a formed on the surfaces of the fourth guide rails 146, by the second transfer rollers 135 and the second auxiliary rollers 136, which are hinge-coupled thereto.

Meanwhile, in FIGS. 58 and 59, third guide bars 157 that unidirectionally rotate and upwardly support the second lower transfer plates 144 separated from the fourth guide rails 146 are installed from an upper side via a side surface to a lower side of the second driving sprockets 141. Third triggers 157a are coupled to ends of the third guide bars 157, respectively, and the third triggers 157a are axially rotated rollers. The third triggers 157a are installed at locations that are in contact with sides of bottom surfaces of the second upper transfer plates 144.

Further, fourth guide bars 159 that unidirectionally rotate and downwardly support the first upper transfer plates 144 separated from the third guide rails 145 are installed from a lower side via a side surface to an upper side of the second driven sprockets 142. Fourth triggers 159a are coupled to ends of the fourth guide bars 159, respectively, and the fourth triggers 159a are axially rotated rollers. The fourth triggers 159a are installed at locations that are in contact with sides of flat surfaces of the second lower transfer plates 144.

Further, a plurality of through-holes 114a are formed in the first transfer plates 114 such that the reheat steam sprayed in the first steam chamber 120 and the second steam chamber 123 comes into contact with the coal particles by passing through the first transfer plates 114. Guards 114b having a specific height are installed at left and right sides of a top surface of the first transfer plates 114 such that the piles of the input coals do not flow down to left sides or right sides of the first transfer plates 114. The guards 114b have an approximately trapezoidal shape, an upper portion of which is wide and a lower portion of which is narrow. Thus, upper portions of the guards 114b of the first transfer plates 114, which are adjacent to each other, overlap each other. Here, it is preferred that the guards 114b of the first transfer plates 114, which are adjacent to each other, are installed in an approximately zigzag direction. Further, shielding plates 114c are installed at left and right sides of bottom surfaces of the first transfer plates 114 such that the reheat steam sprayed in the first steam chamber 120 and the second steam chamber 123 is not dissipated due to spraying thereof to left and right sides of the first steam chamber 120 and the second steam chamber 123, respectively.

Further, a plurality of through-holes 144a are formed in the second transfer plates 144 such that reheat steam sprayed in the third steam chamber 150 and the fourth steam chamber 153 comes into contact with the coal particles by passing through the second transfer plates 144. Guards 144b having a specific height are installed at left and right sides of top surfaces of the second transfer plates 144 such that the piles of the input coals do not flow down to left sides or right sides of the second transfer plates 144. The guards 144b have an approximately trapezoidal shape, an upper portion of which is wide and a lower portion of which is narrow. Thus, upper portions of the guards 144b of the second transfer plates 144, which are adjacent to each other, overlap each other. Here, it is preferred that the guards 144b of the second transfer plates 144, which are adjacent to each other, are installed in an approximately zigzag direction. Further, shielding plates 144c are installed at left and right sides of bottom surfaces of the second transfer plates 144 such that the reheat steam sprayed in the third steam chamber 150 and the fourth steam chamber 153 is not dissipated due to spraying thereof to left and right sides of the third steam chamber 150 and the fourth steam chamber 153, respectively.

Further, in FIG. 59A, the first upper transfer plates 114 are transferred to ends of the first guide rails 115 through rotation of the first driven sprockets 112. In FIG. 59B, as left bottom surface portions of the first upper transfer plates 114 escape from the ends of the first guide rails 115, right bottom surfaces of the first upper transfer plates 114 come into contact with the second triggers 119a of the second guide bars 119. Here, the first upper transfer plates 114 that are hinge-coupled to the first upper chains 113 through the first transfer rollers 133 are separated from the first guide rails 115 and, at the same time, are rotated about the first transfer rollers 133 in a left direction, to fall down loaded piles of coals. Further, in FIG. 59C, the bottom surfaces of the first upper transfer plates 114 are moved downward along the second triggers 119a. In FIG. 59D, the first upper transfer plates 114 are moved along a radius of rotation of the first driven sprockets 112 without rotation in a state in which the bottom surfaces thereof are in contact with the second guide bars 119 while maintaining an approximately upright state. In FIG. 59E, the first upper transfer plates 114 that are moved to a lower portion load and transfer the piles of the coals that fall from first following transfer plates, to the first lower transfer plates 114, while being moved on the second guide rails 116. Further, the piles of the coals loaded on the first lower transfer plates 114 are dried by the reheat steam while being transferred.

Next, in FIG. 58A, the first lower transfer plates 114 are transferred to ends of the second guide rails 116 through rotation of the first driving sprockets 111. In FIG. 58B, as right bottom surface portions of the first upper transfer plates 114 escape from the ends of the second guide rails 116, left flat surfaces of the first lower transfer plates 114 come into contact with the first triggers 117a of the first guide bars 117. Here, the first lower transfer plates 114 that are hinge-coupled to the first lower chains 113 through the first transfer rollers 133 are separated from the second guide rails 116 and, at the same time, are rotated about the first transfer rollers 133 in a left direction, to fall down loaded piles of coals. Further, in FIG. 58C, the flat surfaces of the first upper transfer plates 114 are moved upward along the first triggers 117a. In FIG. 58D, the first lower transfer plates 114 are moved along a radius of rotation of the first driving sprockets 111 without rotation in a state in which the flat surfaces thereof are in contact with the first guide bars 117 while maintaining an approximately upright state. In FIG. 58E, the first lower transfer plates 114 that are moved to an upper portion become the first upper transfer plates 114 while being moved on the second guide rails 115, to load and transfer piles of coals that are input by the fixed quantity coal supplier 400 at a fixed quantity. Further, the piles of the coals loaded on the first upper transfer plates 114 are dried by the reheat steam while being transferred. The piles of the coals that drop onto the first lower transfer plates 114 are discharged to a discharge hole 131 along a first slope 139.

Further, the piles of the coals that drop from the first coal dryer 110 to the discharge hole 131 are input to an inlet 160 of the second coal dryer 140 and are input onto and moved on the surfaces of the second upper transfer plates 144 of the second coal dryer 140 Further, the piles of the coals loaded on the second upper transfer plates 144 are dried by the reheat steam while being transferred.

A process of transferring coals in the second coal dryer 140 is the same as the transfer process of the first coal dryer 110. Further, the piles of the coals that drop onto the second lower transfer plates 144 are discharged to a discharge hole 161 along a second slope 149. Further, the piles of the coals that drop from the second coal dryer 140 to the discharge hole 161 are naturally dried while being supplied and transferred to the third coal dryer 170.

In the present invention, steam supply tubes 121 that supply high-temperature reheat steam generated by the reheater 500 are connected to sides of the first steam chamber 120 and the second steam chamber 123, respectively, and steam supply tubes 151 that supply high-temperature reheat steam generated by the reheater 500 are connected to sides of the third steam chamber 150 and the fourth steam chamber 153, respectively. Further, first steam distribution punched plates 10 through which a plurality of steam spraying holes 11 are formed are coupled to and installed at inner upper portions of the first steam chamber 120, the second steam chamber 123, the third steam chamber 150 and the fourth steam chamber 153, respectively. Each of the first steam chamber 120 to the fourth steam chamber 153 sprays the reheat steam having a uniform pressure through the first steam spraying holes 11.

In addition, the apparatuses according to the first embodiment to the eighth embodiment may be applied as the apparatus for dispersing and flattening for uniform drying of transportation coals in a coal dryer using reheat steam according to the ninth embodiment. Thus, for uniform drying of coals transferred in the coal dryer using the reheat steam, functions such as dispersion, flattening, sorting and residue removal may be included.

In this way, the dispersing and flattening apparatus for uniform drying of transportation coals in a coal dryer using reheat steam deprives moisture contained in coals by using high-temperature reheat steam sprayed through a plurality of through-holes formed through transfer plates while transferring piles of the coals on the plurality of transfer plates that transfers the coals, thereby effectively drying the coals, and has an advantage in that the piles of the coals are uniformly dispersed and flattened so that the high-temperature reheat steam easily comes into contact with coal particles.

While the present invention has been described with respect to the specific embodiments, it will be apparent to those skilled in the art that various changes and modifications may be made without departing from the spirit and scope of the invention as defined in the following claims.

1-37. (canceled)

38. A dispersing and flattening apparatus for uniform drying of a transportation coals in a coal dryer using reheat steam, the coal dryer comprising:
a first coal dryer that comprises a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and
a second coal dryer that comprises a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas,
wherein first transfer rollers are hinge-coupled to between centers of opposite sides of each first transfer plate and the first chains, respectively, first auxiliary rollers are hinge-coupled to side surfaces of the first transfer plate on left and right sides of the first transfer rollers, respectively, second transfer rollers are hinge-coupled to between centers of opposite sides of each second transfer plate and the second chains, respectively, second auxiliary rollers are hinge-coupled to side surfaces of the second transfer plate on left and right sides of the second transfer rollers, respectively, first guide bars that unidirectionally rotate and upwardly support first lower transfer plates separated from the second guide rails are installed from an upper side via a lateral side to a lower side of the first driving sprockets, second guide bars that unidirectionally rotate and downwardly support first upper transfer plates separated from the first guide rails are installed from a lower side via a lateral side to an upper side of the first driven sprockets, third guide bars that unidirectionally rotate and upwardly support second lower transfer plates separated from the fourth guide rails are installed from an upper side via a lateral side to a lower side of the second driving sprockets, fourth guide bars that unidirectionally rotate and downwardly support second upper transfer plates separated from the third guide rails are installed from a lower side via a lateral side to an upper side of the second driven sprockets, and a fixed quantity coal supplier that supplies coals to surfaces of the first transfer plates, which face an upper side, at a fixed quantity is comprised, and
wherein coals that are primarily dried by the first coal dryer are input into the second coal dryer to be secondarily dried,
the dispersing and flattening apparatus comprising a plurality of flatteners, each of which comprises a column-shaped body that is installed on surfaces of the plurality of first transfer plates and second transfer plates, which face an upper side, at a specific interval, a division boss that protrudes from a central portion of a front surface of the body to divide and disperse a central portion of piles of input coals into left and right parts, and a pair of fixing members that are fixed at upper ends of the first guide rails and the second guide rails that horizontally support the first transfer plates and at upper ends of the third guide rails and the fourth guide rails that horizontally support the second transfer plates, and fixedly support opposite ends of the body,
wherein the plurality of flatteners are installed at a specific interval such that a preceding flattener is installed to have a predetermined-height step from the surfaces of the first transfer plates and the second transfer plates to be spaced apart from a following flattener such that they become lower as they go from front to rear, and
wherein the plurality of flatteners reduce loads of piles of transferred coals by flattening the piles of the coals transferred on the surfaces of the first transfer plates and the second transfer flatteners, which face an upper side, such that the piles of the coals become gradually lower at a specific height interval, and allow reheat steam sprayed while passing through the first transfer plates and the second transfer plates to uniformly come into contact with surfaces of coal particles.

39. The dispersing and flattening apparatus of claim 38, wherein each of the plurality of flatteners further comprises a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below.

40. The dispersing and flattening apparatus of claim 39, wherein the dispersion boss has a second intersection line in which the opposite inclined surfaces meet each other, a third intersection line in which a side surface of the division boss and the inclined surfaces of the dispersion boss meet each other, a fourth intersection line corresponding to the blade, in which a bottom surface and the edge of the dispersion boss meet each other, a first intersection point in which the second intersection line and the third intersection line meet each other, a second intersection point in which the second intersection line and the fourth intersection line meet each other, a third intersection point in which the third intersection line and the fourth intersection line meet each other, or the dispersion boss has a second intersection line in which the opposite inclined surfaces of the dispersion boss meet each other, a third intersection line in which the side surface of the division boss and the inclined surfaces of the dispersion boss meet each other, a fourth intersection line corresponding to the blade, in which the bottom surface and the edge of the dispersion boss meet each other, a fifth intersection line in which side surfaces and the body of the dispersion boss meet each other, a first intersection point in which the second intersection line and the third intersection line meet each other, a second intersection point in which the second intersection line and the fourth intersection line meet each other, a third intersection point in which the fourth intersection line and the fifth intersection line meet each other, and a fourth intersection point in which the third intersection line and the fifth intersection line meet each other, wherein the third intersection line and the fourth intersection line are parallel to each other side by side.

41. The dispersing and flattening apparatus of claim 38, wherein the plurality of flatteners are installed at front ends or inside the first flue gas chamber, the second flue gas chamber, the third flue gas chamber and the fourth flue gas chamber.

42. A dispersing and flattening apparatus for uniform drying of a transportation coals in a coal dryer using reheat steam, the coal dryer comprising:
a first coal dryer that comprises a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and
a second coal dryer that comprises a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas,
wherein coals that are primarily dried by the first coal dryer are input into the second coal dryer to be secondarily dried, and
the dispersing and flattening apparatus comprising: first and second dispersion flatteners, each of which comprises a column-shaped body, a division boss that protrudes from a central portion of a front surface of the body, a fixing shaft that is fixed to an upper central portion of a flat surface of the body, a restoration member that is coupled between the fixing shaft and the body to horizontally and elastically support the body with respect to the fixing shaft, and a fixing member that fixedly supports an upper end of the fixing shaft;
a flattener that comprises a column-shaped body, a division boss that protrudes from a central portion of a front surface of the body, and a pair of fixing members that fixedly support opposite ends of the body; and
a pair of transportation coal guide plates which are installed between the first dispersion flattener and the second dispersion flattener and between the second dispersion flattener and the flattener toward insides of the first transfer plates at a specific angle and are located on surfaces of the first transfer plates, and upper ends of which are fixedly supported by support members,
wherein the first dispersion flattener, the second dispersion flattener and the flattener are installed at a specific interval to have a predetermined-height step from the surfaces of the first transfer plates and the second transfer plates such that they become lower as they go from front to rear, and
wherein the first dispersion flattener and the second dispersion flattener disperse piles of coals transferred on the surfaces of the first transfer plates and the second transfer plates, which face an upper side, such that the piles of the coals are not biased to any one side, and the piles of the transferred coals are flattened to become lower by a predetermined-height difference while passing through the first dispersion flattener, the second dispersion flattener and the flattener so that loads of the piles of the transferred coals are reduced and the reheat steam sprayed while passing through the first transfer plates and the second transfer plates uniformly comes into contact with surfaces of coal particles.

43. The dispersing and flattening apparatus of claim 42, wherein the pair of transportation coal guide plates are installed in front of the first dispersing flattener.

44. The dispersing and flattening apparatus of claim 42, wherein each of the first dispersion flattener, the second dispersion flattener and the flattener further comprises a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below.

45. The dispersing and flattening apparatus of claim 42, wherein the first dispersion flattener, the second dispersion flattener, the flattener and the transportation coal guide plates between the first dispersion flattener and the second dispersion flattener and between the second dispersion flattener and the flattener are installed at front ends of or inside the first flue gas chamber, the second flue gas chamber, the third flue gas chamber and the fourth flue gas chamber, respectively.

46. The dispersing and flattening apparatus of claim 42, wherein first transfer rollers are hinge-coupled to between centers of opposite sides of each first transfer plate and the first chains, respectively, first auxiliary rollers are hinge-coupled to side surfaces of the first transfer plate on left and right sides of the first transfer rollers, respectively, second transfer rollers are hinge-coupled to between centers of opposite sides of each second transfer plate and the second chains, respectively, second auxiliary rollers are hinge-coupled to side surfaces of the second transfer plate on left and right sides of the second transfer rollers, respectively, first guide bars that unidirectionally rotate and upwardly support first lower transfer plates separated from the second guide rails are installed from an upper side via a lateral side to a lower side of the first driving sprockets, second guide bars that unidirectionally rotate and downwardly support first upper transfer plates separated from the first guide rails are installed from a lower side via a lateral side to an upper side of the first driven sprockets, third guide bars that unidirectionally rotate and upwardly support second lower transfer plates separated from the fourth guide rails are installed from an upper side via a lateral side to a lower side of the second driving sprockets, fourth guide bars that unidirectionally rotate and downwardly support second upper transfer plates separated from the third guide rails are installed from a lower side via a lateral side to an upper side of the second driven sprockets, and a fixed quantity coal supplier that supplies coals to surfaces of the first transfer plates, which face an upper side, at a fixed quantity is comprised,
wherein the dispersing and flattening apparatus comprises first and second sorters, each of which comprises a rising plate that has a slope that rises at a specific angle as it goes from front to rear, a plurality of first through-holes that are vertically formed in the rising plate at a specific interval to have a specific length, a lowering plate that is bonded to an end of the rising plate and has a slope that is lowered at a specific angle as it goes rearward, and a pair of fixing members that fixedly support the rising plate and the lowering plate that are bonded to each other, and
wherein the first and second sorters are installed at a specific interval and allow reheat steam sprayed while passing through the first transfer plates and the second transfer plates to uniformly come into contact with surfaces of coal particles through sorting that horizontally disperses a density of piles of coals transferred on surfaces of the first transfer plates and the second transfer plates, which face an upper side, and uniformly equalizes the density.

47. The dispersing and flattening apparatus of claim 46, the first sorter and the second sorter are installed at front ends or inside the first flue gas chamber, the second flue gas chamber, the third flue gas chamber and the fourth flue gas chamber.

48. The dispersing and flattening apparatus of claim 46, wherein a plurality of second through-holes are horizontally formed in the lowering plate of each of the first sorter and the second sorter at a specific interval to have a specific width, and a flattening member having elasticity is coupled to a longitudinal cross-section of the lowering plate.

49. The dispersing and flattening apparatus of claim 46, wherein the flattener comprises a first flattener and a second flattener, the first flattener is installed between the first sorter and the second sorter, the second flattener is installed on a rear side of the second sorter, and the first sorter, the first flattener, the second sorter and the second flattener are installed to have a predetermined-height step from the surfaces of the first transfer plates such that they become lower as they go rearward, and
wherein the first sorter and the second sorter horizontally disperse a density of the piles of the coals transferred on the surfaces of the first transfer plates, which face an upper side, and arrange the piles of the coals such that the piles of the coals are uniformly equalized, the first flattener and the second flattener flatten the piles of the coals that have passed through the respective sorters, and the piles of the coals are flattened to become gradually lower by a predetermined height difference while passing through the first sorter, the first flattener, the second sorter and the second flattener, so that loads of the transferred piles of the coals are reduced, and reheat steam sprayed while passing through the first transfer plates and the second transfer plates uniformly come into contact with surfaces of coal particles as well.

50. The dispersing and flattening apparatus of claim 49, wherein the first sorter, the second sorter, the first flattener and the second flattener are installed at front ends or inside the first flue gas chamber, the second flue gas chamber, the third flue gas chamber and the fourth flue gas chamber.

51. The dispersing and flattening apparatus of claim 49, wherein each of the first flattener and the second flattener comprises a dispersion boss that has an edge that protrudes from a front side of a lower edge of the division boss and a blade that protrudes to opposite surfaces of the lower edge of the division boss and has inclined surfaces having a specific slope, which are formed from the edge to the blade and become wider as they go from above to below.

52. The dispersing and flattening apparatus of claim 46, wherein a brush having a plurality of unevennesses that are formed vertically downward is installed on a bottom surface of each of the first sorter and the second sorter, on which the rising plate and the lowering plate are bonded to each other.

53. A dispersing and flattening apparatus for uniform drying of a transportation coals in a coal dryer using reheat steam, the coal dryer comprising:
a first coal dryer that comprises a pair of first driving sprockets and a pair of first driven sprockets that are fastened to each other by first chains to be spaced apart from each other by a specific distance, a plurality of first transfer plates that are hinge-coupled to between the first chains, a pair of first guide rails that are installed below a first upper chain connected between the first driving sprockets and the first driven sprockets to horizontally support first upper transfer plates, a pair of second guide rails that are installed below a first lower chain connected between the first driving sprockets and the first driven sprockets to horizontally support first lower transfer plates, a first steam chamber that is installed below the first upper chain to spray reheat steam supplied by a reheater, a second steam chamber that is installed below the first lower chain to spray the reheat steam supplied by the reheater, a first flue gas chamber that is installed above the first upper chain to collect flue gas, and a second flue gas chamber that is installed above the first lower chain to collect flue gas; and
a second coal dryer that comprises a pair of second driving sprockets and a pair of second driven sprockets that are fastened to each other by second chains to be spaced apart from each other by a specific distance, a plurality of second transfer plates that are hinge-coupled to between the second chains, a pair of third guide rails that are installed below a second upper chain connected between the second driving sprockets and the second driven sprockets to horizontally support second upper transfer plates, a pair of fourth guide rails that are installed below a second lower chain connected between the second driving sprockets and the second driven sprockets to horizontally support second upper transfer plates, a third steam chamber that is installed below the second upper chain to spray the reheat steam supplied by the reheater, a fourth steam chamber that is installed below the second lower chain to spray the reheat steam supplied by the reheater, a third flue gas chamber that is installed above the second upper chain to collect flue gas, and a fourth flue gas chamber that is installed above the lower chain to collect flue gas,
wherein coals that are primarily dried by the first coal dryer are input into the second coal dryer to be secondarily dried, and
the dispersing and flattening apparatus comprising: a first flattener that uniformly disperses piles of coals that fall onto and are transferred on surfaces of the first upper transfer plates, which face an upper side;
a first residue remover that has a plurality of first rakes horizontally spaced apart from each other at a specific interval to protrude from a lower end of a body and rearward bent and connected second rakes protruding from between the first rakes and is installed to be in contact with surfaces of the first lower transfer plates that escape from the first driven sprockets through rotation, to rake and remove coal residues stuck to surfaces of the first transfer plates by using the elastically contacted rakes;
a second flattener that is spaced apart from the first residue remover by a predetermined distance to uniformly disperse and flatten piles of coals that fall onto and are transferred on surfaces of the first lower transfer plates, which face an upper side;
a third flattener that uniformly disperses and flattens piles of coals that fall from the first coal dryer onto surfaces of the second upper transfer plates of the second coal dryer, which face an upper side, and are transferred;
a second residue remover that has a plurality of first rakes horizontally spaced apart from each other at a specific interval to protrude from a lower end of a body and rearward bent and connected second rakes protruding from between the first rakes and is installed to be in contact with surfaces of the second lower transfer plates that escape from the second driven sprockets through rotation, to rake and remove coal residues stuck to surfaces of the second transfer plates by using the elastically contacted rakes; and
a fourth flattener that is spaced apart from the first residue remover by a predetermined distance to uniformly disperse and flatten piles of coals that fall onto and are transferred on surfaces of the second lower transfer plates, which face an upper side,
wherein each of the first flattener to the fourth flattener comprises a column-shaped body, a division boss that protrudes from a center of a front surface of the body, and a pair of fixing members that fixedly support opposite ends of the body, and
wherein each of a first divider having a plurality of first division bosses that are horizontally spaced apart from each other at a specific interval to protrude from a lower portion of a body, a second divider that has a plurality of second division bosses that are horizontally spaced apart from each other at a specific interval to protrude from a lower portion of a body and is formed on a rear side of the first divider at a specific interval such that the second division bosses are located between the first division bosses that protrude from the first divider and a dispersion flattener that has a division boss protruding from a central portion of a front surface of a column-shaped body and is installed on a rear side of the second divider at a specific interval is installed inside the first flue gas chamber, the second flue gas chamber, the third flue gas chamber and the fourth flue gas chamber, so that while plies of coals that are loaded and transferred on surfaces of the respective transfer plate, which face an upper side, are divided, collected, dispersed and flattened, the coals are dried.
